(19) United States
(12) Patent Application Publication
(10) Pub. No.: US 2025/0094655 A1
(43) Pub. Date: Mar. 20, 2025

(54) PLANT DESIGN ASSISTANCE APPARATUS, AND PLANT DESIGN ASSISTANCE METHOD

(71) Applicant: JGC CORPORATION, Kanagawa (JP)

(72) Inventors: Naotaka SHIDA, Kanagawa (JP); Rie SHIMIZU, Kanagawa (JP); Norifusa AKAGI, Kanagawa (JP); Tsutae SUGANUMA, Kanagawa (JP); Koya NISHIMOTO, Kanagawa (JP); Nobutaka TANAKA, Kanagawa (JP); Hirofumi YOSHII, Kanagawa (JP)

(73) Assignee: JGC CORPORATION, Kanagawa (JP)

(21) Appl. No.: 18/727,683

(22) PCT Filed: Jan. 13, 2023
(86) PCT No.: PCT/JP2023/000698

§ 371 Date: Jul. 9, 2024

(30) Foreign Application Priority Data
Jan. 26, 2022 (WO) PCT/JP2022/002745

(51) Int. Cl. G06F 30/13; G06F 30/18

(52) U.S. Cl. CPC G06F 30/13; G06F 30/18

(57) ABSTRACT

A plant design assistance apparatus and a plant design assistance method are provided. The plant design assistance assists in wiring design of relay devices, each serving as a relay between a primary cable connected to a control room installed in a plant and multiple secondary cables respectively connected to multiple devices. The plant design assistance apparatus includes: an information acquisition unit which acquires, as plant design information, an installation position of the control room, an installation position of each of the devices, and a primary cable installation region in a layout diagram of the plant and acquires a relay device wiring design condition; and a determination unit which determines an installation position of a relay device in the layout diagram and allocation of a device connected to the relay device based on the plant design information and the relay device wiring design condition acquired by the information acquisition unit

### TECHNICAL FIELD

The present invention relates to a plant design assistance apparatus and a plant design assistance method.

### BACKGROUND ART

Plants have a large number of devices installed therein, and process control, emergency stop, security management, and the like are performed based on device signals transmitted and received between those large number of devices and a control room. The devices are installed at various portions of the plant, and hence, as an apparatus for assisting in design of electric wiring in the plant, for example, in Patent Literature 1, there is disclosed a plant electric wiring planning apparatus for generating a route diagram of electric wiring for connecting a plurality of devices to each other.

In the plant electric wiring planning apparatus as disclosed in Patent Literature 1, under a state in which a connection relationship between a device (pump, valve, instrumentation device, or the like) and a control panel is determined in advance, a route diagram of electric wiring which connects the device and the control panel to each other is generated.

### CITATION LIST

### Patent Literature

[Patent Literature 1] JP 2020-135381 A

### SUMMARY OF INVENTION

### Technical Problem

It is required to achieve wiring between the device and the control room through use of a cable, but, when a cable is installed one by one for each of the large number of devices to reach the control room, the installation cost is high and the workability is also bad. In view of the above, a relay device is installed between the device and the control room so as to adopt a connection mode in which a secondary cable (for example, a single-core cable) is used for connection from each of the plurality of devices to the relay device and a primary cable (for example, a multi-core cable) is used for connection from the relay device to the control room. Such a connection mode using the relay device requires work of determining, in a layout diagram of the plant, an installation position of each relay device and allocation of a device connected to each relay device. At this time, it is required to satisfy various design conditions, such as the primary cable being desired to be installed in a specific region and the secondary cable being desired to be shorter than a specific length. Accordingly, in the wiring design of the relay device, in order to appropriately carry out design in a short period or a design change due to a specification change, advanced design skills based on experiences in construction sites have been required.

The present invention has been made in view of the above-mentioned problem, and has an object to provide a plant design assistance apparatus and a plant design assistance method with which wiring design of a relay device can be appropriately carried out without requiring advanced design skills.

### Solution to Problem

In order to achieve the above-mentioned object, according to one aspect of the present invention, there is provided a plant design assistance apparatus for assisting in wiring design of a plurality of relay devices each serving as a relay between a primary cable to be connected to a control room installed in a plant and a plurality of secondary cables to be connected to a plurality of devices, respectively, the plurality of devices being installed in the plant, the plant design assistance apparatus including: an information acquisition unit configured to: acquire, as plant design information, an installation position of the control room, an installation position of each of the plurality of devices, and a primary cable installation region indicating a region in which the primary cable is installable, in a layout diagram of the plant; and acquire a relay device wiring design condition regarding the wiring design of the plurality of relay devices; and a determination unit configured to determine an installation position of a relay device in the layout diagram and allocation of a device connected to the relay device, based on the plant design information and the relay device wiring design condition acquired by the information acquisition unit.

### Advantageous Effects of Invention

According to the plant design assistance apparatus of the one aspect of the present invention, the determination unit determines the installation position of the relay device in the layout diagram and the allocation of the device connected to the relay device based on the plant design information and the relay device wiring design condition, and hence the wiring design of the relay device can be appropriately carried out without requiring advanced design skills.

Problems, configurations, and effects other than those described above become apparent in the “Description of Embodiments” section described later.

### BRIEF DESCRIPTION OF DRAWINGS

FIG. 1 is an overall diagram for illustrating an example of a plant design assistance system 1 and a plant 10.

FIG. 2 is a block diagram for illustrating an example of a plant design assistance apparatus 2.

FIG. 3 is a data configuration diagram for illustrating an example of a plant design database 5 and a design condition database 6.

FIG. 4 is a diagram for illustrating an example of a plot plan diagram 500.

FIG. 5 is a diagram for illustrating an example of a P&ID diagram 501.

FIG. 6 is a diagram for illustrating an example of an I/O list 502.

FIG. 7 is a diagram for illustrating an example of a wiring block diagram 503.

FIG. 8 is a function explanatory diagram for illustrating a first processing example of relay device wiring design processing performed by a determination unit 202.

FIG. 9 is a function explanatory diagram for illustrating the first processing example of the relay device wiring design processing performed by the determination unit 202 (subsequent to FIG. 8).

FIG. 10 is a function explanatory diagram for illustrating the first processing example of the relay device wiring design processing performed by the determination unit 202 (subsequent to FIG. 9).

FIG. 11 is a function explanatory diagram for illustrating a second processing example of the relay device wiring design processing performed by the determination unit 202.

FIG. 12 is a hardware configuration diagram for illustrating an example of a computer 900 forming each of the plant design assistance apparatus 2 and a designer terminal apparatus 3.

FIG. 13 is a flow chart for illustrating an example of an operation of the plant design assistance system 1.

FIG. 14 is a flow chart for illustrating the example of the operation of the plant design assistance system 1 (subsequent to FIG. 13).

FIG. 15 is a flow chart for illustrating details of the relay device wiring design processing (Step S130) performed by the determination unit 202.

FIG. 16 is a function explanatory diagram for illustrating a first modification example of the relay device wiring design processing.

FIG. 17 is a function explanatory diagram for illustrating a second modification example of the relay device wiring design processing.

FIG. 18 is a function explanatory diagram for illustrating a third modification example of the relay device wiring design processing.

FIG. 19 is a function explanatory diagram for illustrating a fourth modification example of the relay device wiring design processing.

FIG. 20 is a function explanatory diagram for illustrating a fifth modification example of the relay device wiring design processing.

FIG. 21 is a function explanatory diagram for illustrating a sixth modification example of the relay device wiring design processing.

### DESCRIPTION OF EMBODIMENTS

Embodiments for carrying out the present invention are described below with reference to the drawings. In the following description, a range required for the description for achieving the object of the present invention is schematically shown, and a range required for the description of a portion corresponding to the present invention is mainly described. A portion of which the description is omitted is based on a known technology.

### Configuration of Plant Design Assistance System 1

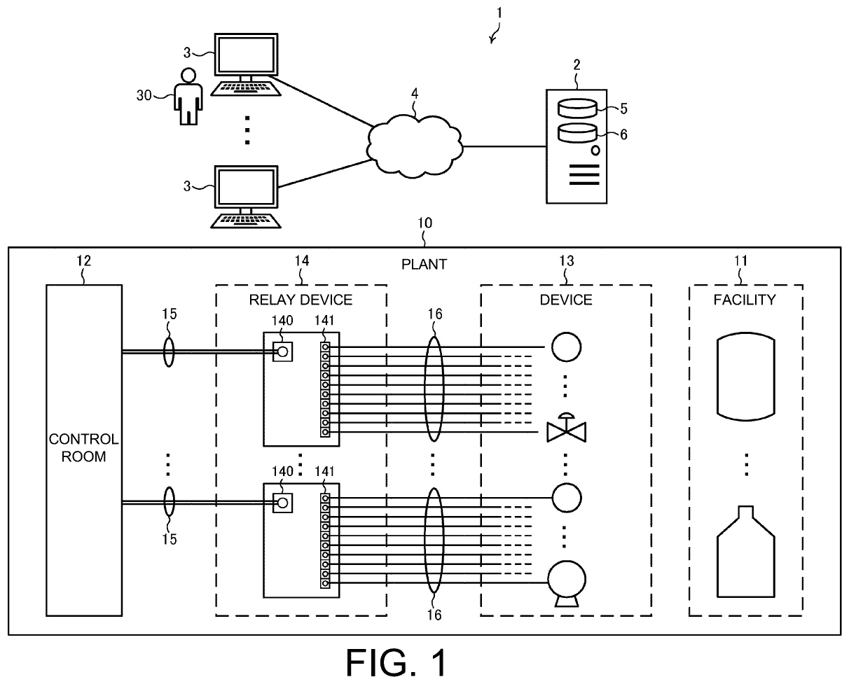

FIG. 1 is an overall diagram for illustrating an example of a plant design assistance system 1 and a plant 10. The plant design assistance system 1 functions as a system for assisting in design of the plant 10, in particular, wiring design of a relay device 14 installed in the plant 10. The plant 10 is, for example, any plant, such as a natural gas plant, a petroleum processing plant, a chemical processing plant, a power generation plant, or a steel plant, and is not limited to those examples.

The plant 10 has installed therein, for example, as various facilities 11 for processing any fluid, such as gas, liquid, or a granular material having flowability, a reaction column, a fractionator column, a tank, a boiler, a heating furnace, a heat exchanger, and pipes, to thereby perform a predetermined manufacturing process. Further, the plant 10 has installed therein a control room 12 for performing control of a manufacturing process, emergency stop, and security monitoring of the plant 10, a plurality of devices 13 for transmitting and receiving various device signals (sensor signal and control signal) to and from the control room 12, and a plurality of relay devices 14 connected between the control room 12 and the plurality of devices 13 so as to relay the device signals.

In the plant 10, for example, a plurality of management systems, such as a process control system, an emergency stop system, and a security system, are operated. The process control system is a management system for controlling the manufacturing process for manufacturing a product from a raw material. The emergency stop system is a management system for detecting abnormality of the facility 11 or the device 13 while the manufacturing process is being executed, to thereby perform emergency stop of the manufacturing process. The security system is a management system for detecting dangerous gas leakage, fire, and the like, and activating evacuation alert to workers or a fire-extinguisher system.

Examples of the device 13 include instruments such as sensors for measuring a flow rate, a pressure, a temperature, a liquid level, a component, or the like of the fluid flowing through the facility 11 and outputting sensor signals indicating results of the measurement, and control devices, such as a valve, a pump, and a compressor, to which the control signal is input to control the flow rate, the pressure, the temperature, the liquid level, the component, or the like of the fluid flowing through the facility 11. The device 13 is not limited to the above-mentioned examples. The device 13 may include a part of the facility 11, may be an instrument for measuring physical quantities, such as a temperature and a humidity, in the ambient environment of the facility 11, or include a control device for controlling those physical quantities.

The control room 12 includes, for example, a control apparatus (not shown) for each management system. The control room 12 receives a sensor signal (also referred to as “input signal”) from a device 13 functioning as an instrument among the plurality of devices 13, and transmits, based on sensor information indicated by this sensor signal, a control signal (also referred to as “output signal”) to a device 13 functioning as a control device among the plurality of devices 13. A plurality of control rooms 12 may be installed for one plant 10, or a plurality of control rooms 12 may be installed for each management system. Further, the control apparatus may be shared by a plurality of management systems.

The relay device 14 is, for example, a box-shaped electrical device called a junction box. The relay device 14 includes a primary terminal 140 and a plurality of secondary terminals 141. A primary cable 15 connected to the control room 12 is wire-connected to the primary terminal, and a secondary cable 16 connected to the device 13 is wire-connected to the secondary terminal. The relay device 14 serves as a relay between the primary cable 15 and the secondary cable 16 so as to relay device signals transmitted and received between the control room 12 and the plurality of devices 13. The relay device 14 varies in specification, such as the maximum terminal number of secondary terminals 141 and whether the relay device 14 is a device for an analog signal or a device for a digital signal, and relay devices 14 having a plurality of specifications are used in the plant 10. The relay device 14 may include a plurality of primary terminals 140.

As the primary cable 15, for example, a multi-core cable for transmitting and receiving a plurality of device signals is used. As the secondary cable 16, a single-core cable for transmitting and receiving a single device signal is basically used, but a multi-core cable may be used. Each of the single-core cable and the multi-core cable may be a cable using a pair of cores for one device signal. In this case, as the primary terminal 140 and the secondary terminal 141, a pair of terminals is used for one device signal, and hence a value of the maximum signal connection number of secondary terminals 141 (corresponding to the half of the maximum terminal number) may be used in place of the maximum terminal number of secondary terminals 141. Thus, when the maximum connection signal number of secondary terminals 141 at the time of using a single-core cable including a pair of cores is five, the relay device 14 includes ten secondary terminals 141 as the physical number of terminals.

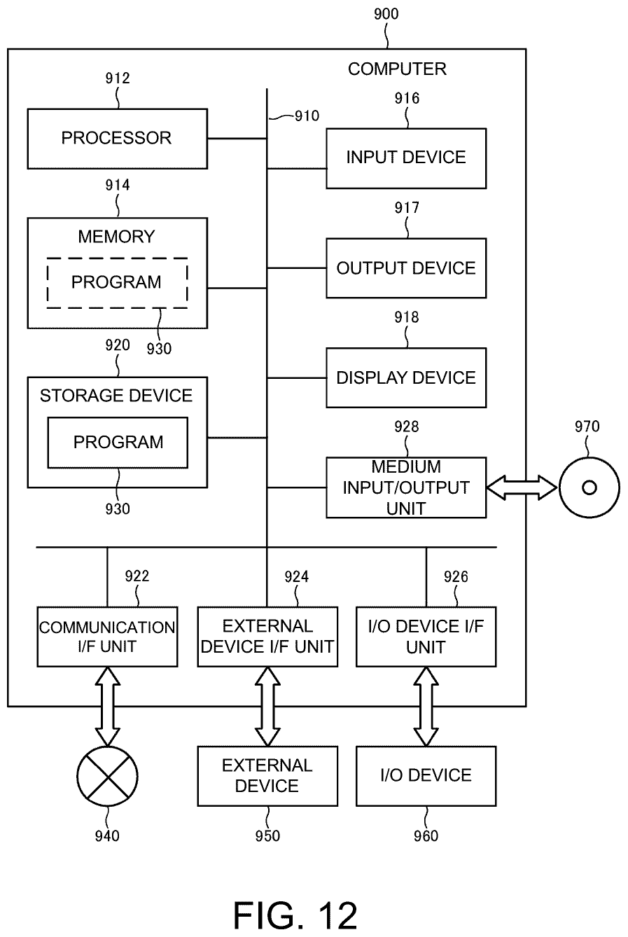

The plant design assistance system 1 includes, as main components thereof, a plant design assistance apparatus 2 and a designer terminal apparatus 3. The plant design assistance apparatus 2 is provided to assist in wiring design of the plurality of relay devices 14 installed in the plant 10, and the designer terminal apparatus 3 is used by a designer of the plant 10. Each of the plant design assistance apparatus 2 and the designer terminal apparatus 3 is formed of, for example, a general-purpose or dedicated computer (see FIG. 12 to be referred to later), and is connected to a wired or wireless network 4 so as to allow mutual transmission and reception of various types of data. The number of plant design assistance apparatus 2, the number of designer terminal apparatus 3, and the configuration of the network 4 are not limited to those in the example of FIG. 1.

The plant design assistance apparatus 2 is formed of, for example, a server-type computer or a cloud-type computer. The plant design assistance apparatus 2 includes a plant design database 5 and a design condition database 6. The plant design database 5 is provided to manage plant design information 50 of each plant 10, and the design condition database 6 is provided to manage a design request, a design procedure, a design rule, and the like used when each plant 10 is designed. In this embodiment, description is mainly given of a configuration and an operation at the time when the plant design assistance apparatus 2 cooperates with the designer terminal apparatus 3 to assist in the wiring design of the relay device 14 as a part of instrumentation design included in detail design, but the plant design assistance apparatus 2 and the designer terminal apparatus 3 may assist in basic design or detail design other than the wiring design of the relay device 14, in the overall design of the plant 10.

The designer terminal apparatus 3 is formed of, for example, a stationary-type computer or a portable-type computer, and is used by a designer 30. The designer terminal apparatus 3 has a program, such as an application or a browser, installed therein, and receives various input operations and further outputs various types of information via a display screen or sound. The designer terminal apparatus 3 transmits or receives various types of data to or from the plant design assistance apparatus 2. Thus, the designer terminal apparatus 3 assists in the wiring design of the relay device 14 by, for example, displaying contents of the plant design database 5 or the design condition database 6 on a display screen, and receiving various input operations on this display screen to register new data in the plant design database 5 or the design condition database 6 or to correct the registered data.

### Configuration of Plant Design Assistance Apparatus 2

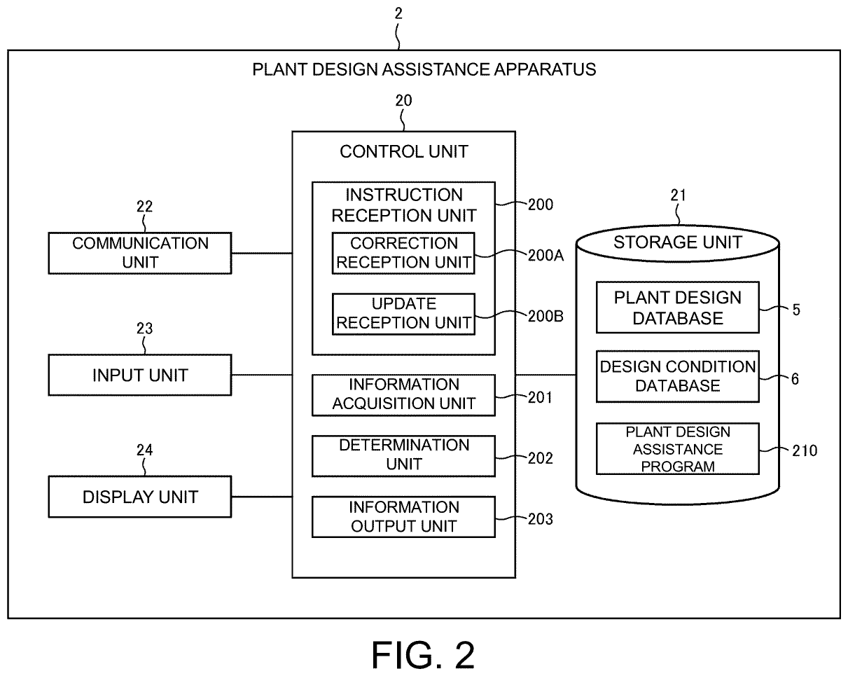

FIG. 2 is a block diagram for illustrating an example of the plant design assistance apparatus 2. The plant design assistance apparatus 2 includes a control unit 20, a storage unit 21, a communication unit 22, an input unit 23, and a display unit 24. The control unit 20 is formed of a processor or the like. The storage unit 21 is formed of an HDD, an SSD, a memory, or the like. The communication unit 22 serves as a communication interface with respect to the network 4. The input unit 23 is formed of a keyboard, a mouse, or the like. The display unit 24 is formed of a display or the like. The input unit 23 and the display unit 24 may be omitted.

The storage unit 21 stores the plant design database 5, the design condition database 6, and a plant design assistance program 210, and also stores an operating system, other programs, various types of data, and the like.

The control unit 20 executes the plant design assistance program 210 stored in the storage unit 21 to function as an instruction reception unit 200, an information acquisition unit 201, a determination unit 202, and an information output unit 203.

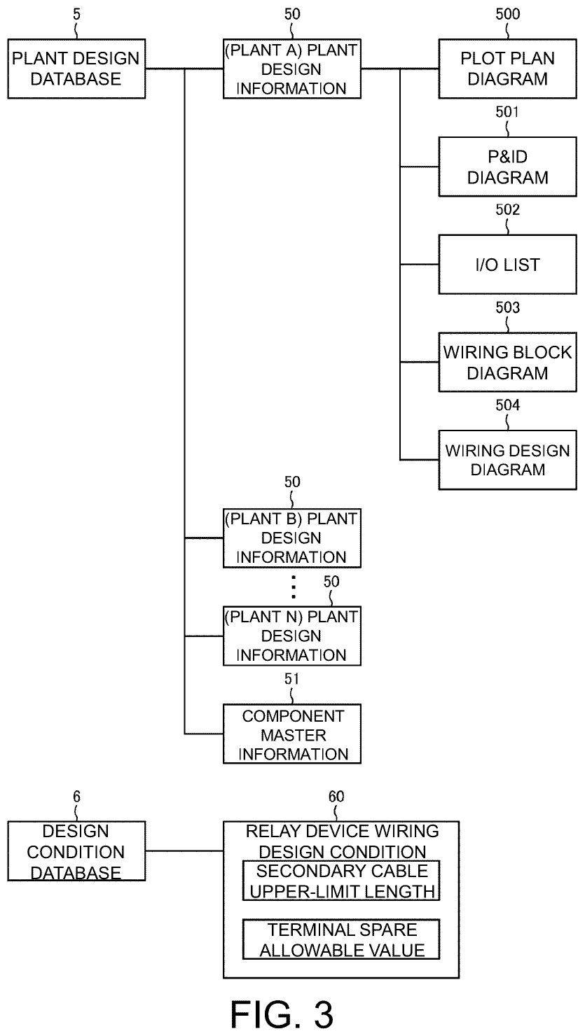

FIG. 3 is a data configuration diagram for illustrating an example of the plant design database 5 and the design condition database 6.

The plant design database 5 is formed of plant design information 50 which is design data of each plant 10 (in the example of FIG. 3, plants A, B, . . . , and N), and component master information 51 to be referred to by the plant design information 50.

The plant design information 50 is generated through design work of the plant 10, and is formed of, for example, a plot plan diagram 500, a piping & instrument diagram (P&ID diagram) 501, an input/output (I/O) list 502, a wiring block diagram 503, and a wiring design diagram 504. The plot plan diagram 500, the P&ID diagram 501, the I/O list 502, the wiring block diagram 503, and the wiring design diagram 504 may be generated for, for example, each management system or each floor area.

For the facility 11, the device 13, the relay device 14, the primary cable 15, and the secondary cable 16 installed in the plant 10, a facility ID, a device ID, a relay device ID, and a cable ID are given as information indicating, for example, a unique identification number, a unique identification code, a unique identification name, or a unique identification tag (numbers, letters, or a combination thereof). In the plot plan diagram 500, the P&ID diagram 501, the I/O list 502, the wiring block diagram 503, and the wiring design diagram 504, the facility ID, the device ID, the relay device ID, and the cable ID are used so that pieces of information between those pieces of data are associated with each other. Further, a component ID to be managed by the component master information 51 is assigned to each of the facility 11, the device 13, the relay device 14, the primary cable 15, and the secondary cable 16 so that, when the component master information 51 is referred to based on this component ID, the specification of each of the facility 11, the device 13, the relay device 14, the primary cable 15, and the secondary cable 16 is identified.

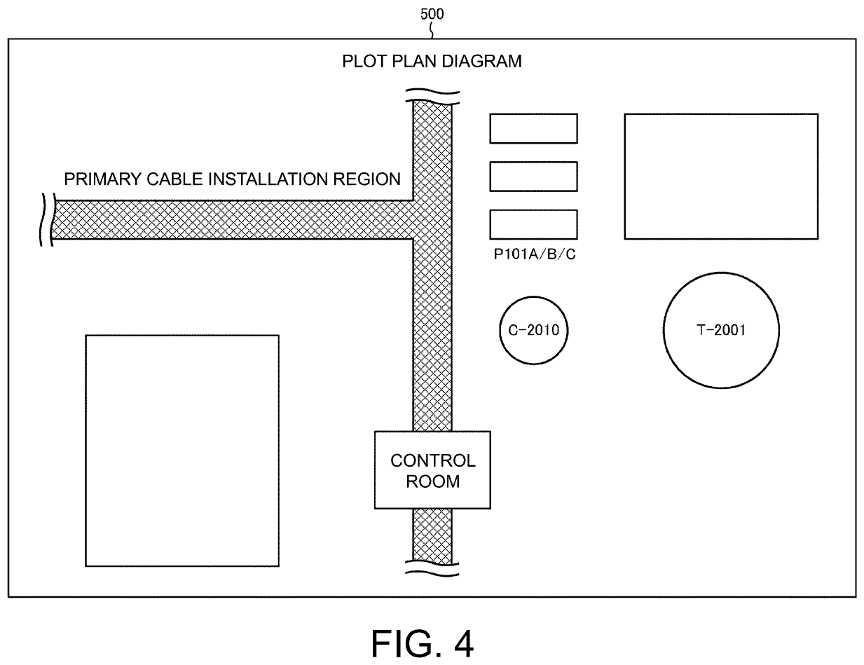

FIG. 4 is a diagram for illustrating an example of the plot plan diagram 500. The plot plan diagram 500 is data having a layout diagram of the plant 10 recorded therein. In the plot plan diagram 500, there are recorded, for example, an installation position (X coordinate and Y coordinate) and an installation height (Z coordinate) of the facility 11, an installation position (X coordinate and Y coordinate) of the control room 12, a primary cable installation region indicating a region in which the primary cable 15 is installable, a relay device installable height (Z coordinate) indicating a height at which the relay device 14 is installable, and a secondary cable installable height (Z coordinate) indicating a height at which the secondary cable 16 is installable.

The primary cable installation region is, for example, a region in which a cable duct for the primary cable 15 is installed. As the cable duct, any method, such as a ceiling embedding method, a ceiling suspending method, a floor groove method, or an underfloor method, can be adopted. The relay device installable height is, for example, a height from a floor surface at the time of installing the relay device 14, and may have a predetermined range. The secondary cable installable height is, for example, a height from the floor surface at the time of wiring the secondary cable 16. For example, a height of a ceiling surface is designated therefor.

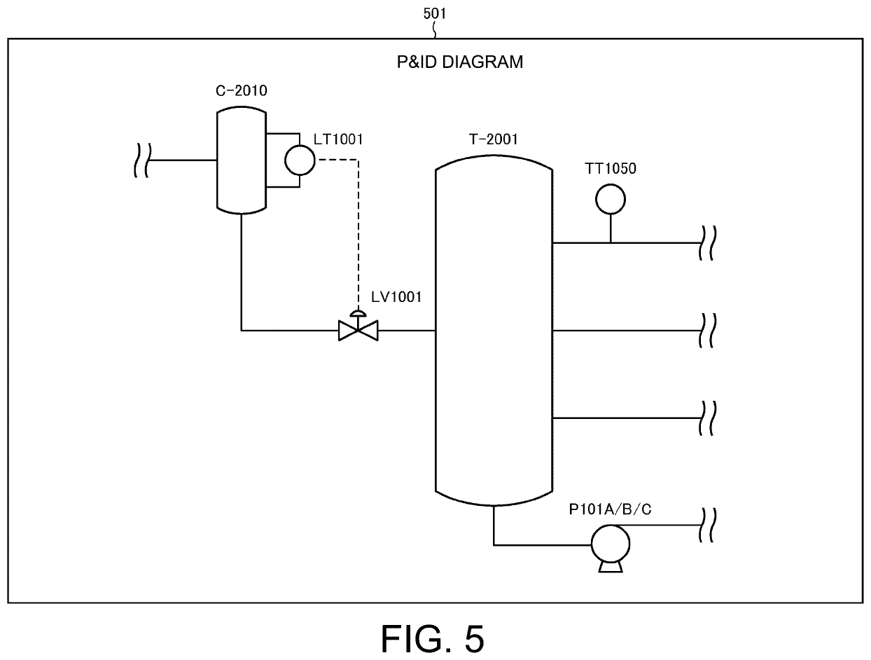

FIG. 5 is a diagram for illustrating an example of the P&ID diagram 501. The P&ID diagram 501 is data having recorded therein a flow of the manufacturing process and an arrangement relationship or a physical connection relationship between the facility 11 and the device 13.

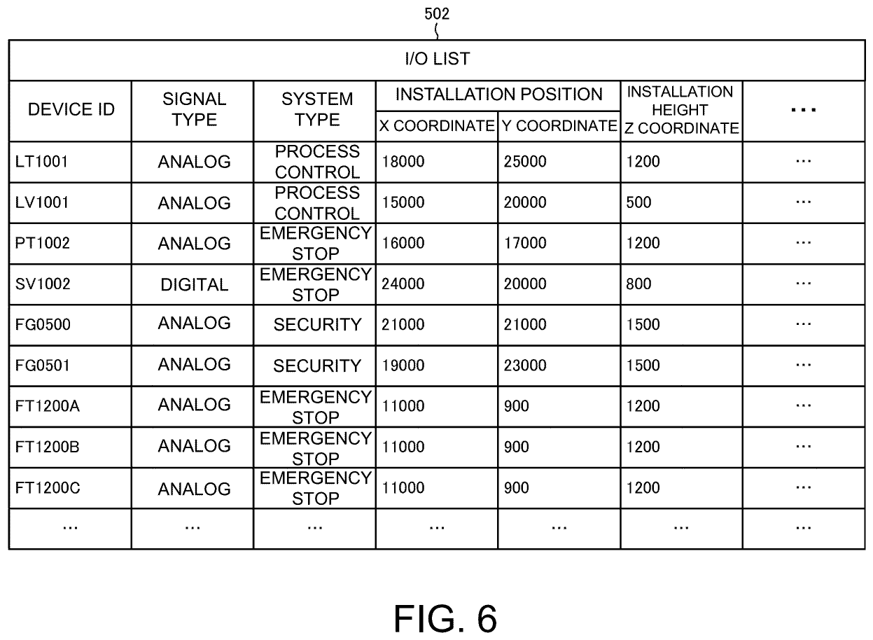

FIG. 6 is a diagram for illustrating an example of the I/O list 502. The I/O list 502 is data having recorded therein an attribute of the device signal transmitted to and received from the device 13 in, for example, a table format.

In the I/O list 502, as the attribute of the device signal, a device ID, a signal type, a system type, an installation position (X coordinate and Y coordinate), an installation height (Z coordinate), and the like are stored. The signal type is information specifying whether the signal is an analog signal or a digital signal. The system type is information specifying in which management system among the plurality of management systems operating in the plant 10 (in this embodiment, the process control system, the emergency stop system, and the security system) the device is to be used.

The installation position and the installation height of each device 13 in the I/O list 502 are recorded as results acquired by, for example, analyzing the plot plan diagram 500 and the P&ID diagram 501 so as to identify the arrangement relationship or the physical connection relationship between the facility 11 and the device 13 from the P&ID diagram 501 and to further identify the installation position and the installation height of each facility 11 from the plot plan diagram 500. The installation position and the installation height of each device 13 may be recorded in the plot plan diagram 500 or other data. In this case, the installation position and the installation height of the device 13 in the I/O list 502 may be omitted.

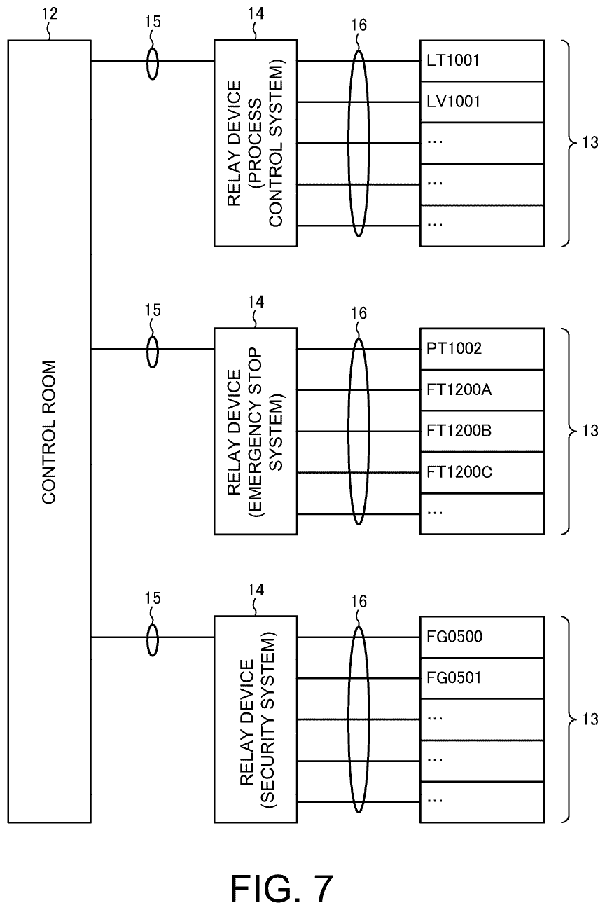

FIG. 7 is a diagram for illustrating an example of the wiring block diagram 503. The wiring block diagram 503 is data having recorded therein an electrical connection relationship among the control room 12, the device 13, the relay device 14, the primary cable 15, and the secondary cable 16.

In the wiring block diagram 503, an installation specification of the relay device 14 and allocation of the device 13 connected to the relay device 14 are recorded by performing the wiring design of the relay device 14. The allocation of the device 13 is information specifying the device 13 to be wire-connected to each of the plurality of secondary terminals 141 via the secondary cable 16. The installation specification of the relay device 14 is, for example, information specifying the specification of the relay device 14 by referring to the component master information based on the component ID being assigned to the relay device 14.

The wiring design diagram 504 is a layout diagram regarding the wiring design of the relay device 14, and is data having recorded therein, for example, a layout diagram that can be layered (superimposed) on the plot plan diagram 500. In the wiring design diagram 504, the installation position (X coordinate and Y coordinate) of the relay device 14, a route of the primary cable 15, a route of the secondary cable 16, and the like are recorded by performing the wiring design of the relay device 14. Some or all of pieces of data stored in the wiring design diagram 504 may be recorded in the plot plan diagram 500 or other data.

The component master information 51 is data for managing various components of, for example, the facility 11, the device 13, the relay device 14, the primary cable 15, and the secondary cable 16. The component master information 51 has a record for each component, and has a field in which, for example, a component ID, a name, a large category, a small category, a specification, and a size can be registered.

The design condition database 6 is data having recorded therein a design request, a design procedure, a design rule, and the like used when each plant 10 is designed, and is formed of a relay device wiring design condition 60 regarding the wiring design of the relay device.

In the relay device wiring design condition 60, as illustrated in FIG. 3, for example, a secondary cable upper-limit length, a terminal spare allowable value, and the like are stored. The secondary cable upper-limit length is information indicating an upper limit value of a length of the secondary cable 16. The terminal spare allowable value is information indicating an allowable value of a spare ratio or a spare number of the secondary terminals 141 of the relay device 14 to which the secondary cable 16 is connected. The relay device wiring design condition 60 is not limited to the above-mentioned example, and may include, for example, an upper limit value of the number of relay devices 14 to be installed and a specification of an installable relay device 14. Further, the relay device wiring design condition 60 may be prepared separately for each plant 10, or may be shared by a plurality of plants 10.

The plant design database 5 and the design condition database 6 are referred to by the designer terminal apparatus 3, and thus an editing operation, such as addition, deletion, or correction, of each piece of data is performed by the designer 30 on the display screen of the designer terminal apparatus 3. At this time, in the work of referring to and editing the database 5 and the design condition database 6, authority control is performed in accordance with the permission authority that each designer has. Further, the plant design database 5 and the design condition database 6 cooperate with a CAD system so that each piece of data (for example, the component master information 51) is updated as required.

Data configurations of the plant design database 5 and the design condition database 6 are not limited to the above-mentioned example, and may be changed as appropriate. A part of the above-mentioned data may be omitted, or data other than the above-mentioned data may be added. Further, the plant design database 5 and the design condition database 6 can adopt any data format. For example, an XML format or a CAD format may be adopted, or a plurality of data formats may be combined with each other as appropriate.

The instruction reception unit 200 transmits display screen information for displaying various display screens to the designer terminal apparatus 3, and receives an input operation performed by the designer 30 via this display screen. Thus, the instruction reception unit 200 functions as a user interface with respect to the designer 30 who performs the wiring design of the relay device 14. The instruction reception unit 200 receives, for example, a selection instruction to select the plant 10 that becomes a target of the wiring design of the relay device 14 and an execution instruction to execute relay device wiring design processing of determining the installation position of the relay device 14, the allocation of the device 13, and the like. The relay device wiring design processing is executed by the determination unit 202 to be described later.

Further, the instruction reception unit 200 functions as a correction reception unit 200A and an update reception unit 200B. The correction reception unit 200A receives a correction instruction to correct part of information of at least one of the installation position of the relay device 14 or the allocation of the device 13 determined in the relay device wiring design processing. The update reception unit 200B receives an update instruction to update part of information of at least one of the plant design information 50 or the relay device wiring design condition 60 and a change prohibiting instruction to designate a change prohibited range for prohibiting a change of information of at least one of the installation position of the relay device 14 or the allocation of the device 13 determined in the relay device wiring design processing.

The information acquisition unit 201 refers to, for example, the plant design database 5 to acquire, as the plant design information 50, the installation position of the control room 12, the installation position of the device 13, and the primary cable installation region in the layout diagram of the plant 10. At this time, the information acquisition unit 201 may acquire the installation position and the installation height of each device 13 by analyzing, for example, the plot plan diagram 500 and the P&ID diagram 501 included in the plant design information 50 so as to identify the arrangement relationship or the physical connection relationship between the facility 11 and the device 13 from the P&ID diagram 501 and to further identify the installation position and the installation height of each facility 11 from the plot plan diagram 500. The information acquisition unit 201 may record the acquired results to the I/O list 502. The information acquisition unit 201 may acquire data other than the above-mentioned data as long as the data is included in the plant design information 50. For example, the information acquisition unit 201 may further acquire the installation height of the device 13, the relay device installable height, and the secondary cable installable height, or may further acquire the attribute of the device signal.

Further, the information acquisition unit 201 refers to, for example, the design condition database 6 to acquire the relay device wiring design condition 60. The information acquisition unit 201 acquires, as the relay device wiring design condition 60, for example, the secondary cable upper-limit length and the terminal spare allowable value.

A part or the whole of the plant design database 5 or a part or the whole of the design condition database 6 may be stored in an external apparatus (which may be a plurality of external apparatus) connectable to the network 4. In this case, the information acquisition unit 201 may acquire the plant design information 50 and the relay device wiring design condition 60 from this external apparatus via the network 4 and the communication unit 22. Further, a part or the whole of the plant design database 5 or a part or the whole of the design condition database 6 may be stored in any storage medium. In this case, the information acquisition unit 201 may acquire the plant design information 50 and the relay device wiring design condition 60 from this storage medium (which may be a plurality of storage media).

The determination unit 202 performs the relay device wiring design processing of determining the installation position of the relay device 14 in the layout diagram and the allocation of the device 13 connected to the relay device 14, based on the plant design information 50 and the relay device wiring design condition 60 acquired by the information acquisition unit 201.

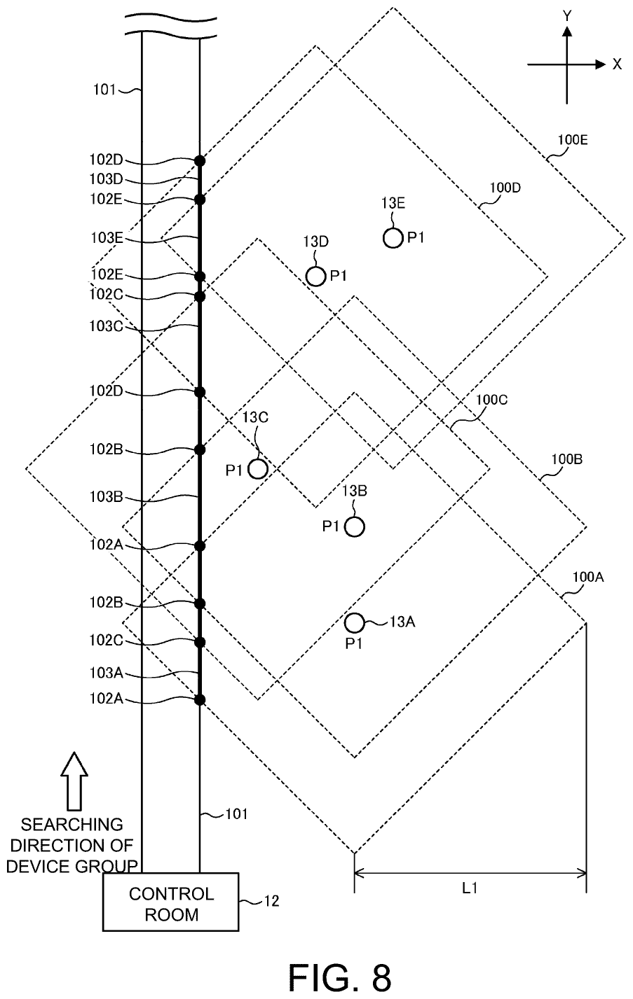

As a first processing example of the relay device wiring design processing (see FIG. 8 to FIG. 10 to be referred to later), the determination unit 202 arranges, into the layout diagram of the plant 10, through use of the installation position of the device 13 as a reference, an imaginary frame defined by a secondary cable upper-limit length L1 for each device 13 so as to generate, for each device 13, an intersecting line segment connecting intersections between the imaginary frame and an outer shape line of the primary cable installation region to each other. In addition, the determination unit 202 searches for, from the control room 12 serving as a starting point, an overlapping line segment in which the intersecting line segments of the respective devices 13 overlap each other, to thereby identify the device 13 corresponding to the intersecting line segment including the overlapping line segment as a device group. Thus, the determination unit 202 determines, for each device group, the installation position of the relay device 14 on an inner side of the overlapping line segment, and further determines the allocation of the device 13 such that the device 13 corresponding to the intersecting line segment including the overlapping line segment is connected to the relay device 14.

FIG. 8 to FIG. 10 are function explanatory diagrams for illustrating the first processing example of the relay device wiring design processing performed by the determination unit 202. In FIG. 8 to FIG. 10, for the sake of simplifying the description, description is given of the relay device wiring design processing in a situation in which five devices 13A to 13E are installed as the devices 13.

First, as illustrated in FIG. 8, the determination unit 202 arranges, into the layout diagram of the plant 10, through use of installation positions Pl (white circles) of the respective devices 13A to 13E as references, imaginary frames 100A to 100E (broken lines) defined by the secondary cable upper-limit length L1, for the respective devices 13A to 13E. In this embodiment, the shape of each of the imaginary frames 100A to 100E is a rhombus. As the size of the rhombus, through use of the installation position P1 of each of the devices 13A to 13E as a center, a distance from this center to each point is defined as the secondary cable upper-limit length L1. The reason why a rhombus is adopted is because, in a case of assuming that the secondary cable 16 is wired along the X direction and the Y direction, a range in which the secondary cable 16 having the secondary cable upper-limit length L1 can reach from the installation position P1 of each of the devices 13A to 13E serving as a center forms a rhombus shape. The shape of the imaginary frame 100 may be, for example, a circle or other shapes. In the case of the circle, a radius of the circle may be defined by the secondary cable upper-limit length L1.

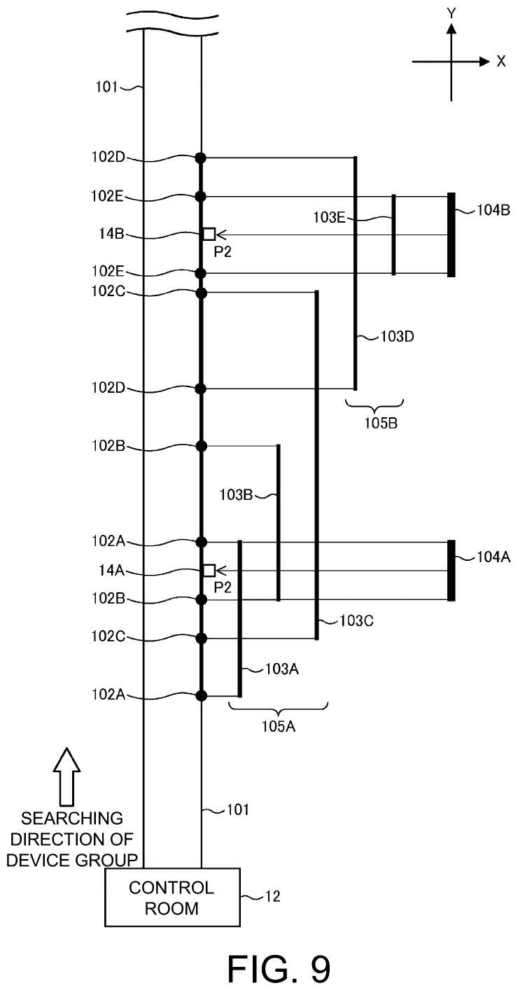

Next, the determination unit 202 identifies two intersections 102A to 102E (black circles) at which an outer shape line 101 of the primary cable installation region and each of the imaginary frames 100A to 100E intersect with each other, and generates, for the respective devices 13A to 13E, intersecting line segments 103A to 103E each connecting the two intersections 102A to 102E to each other. In FIG. 9, for the sake of facilitating the description, the five intersecting line segments 103A to 103E are illustrated under a shifted state.

Next, as illustrated in FIG. 9, the determination unit 202 searches for, from the control room 12 serving as a starting point, overlapping line segments 104A and 104B in which the intersecting line segments 103A to 103E of the respective devices 13A to 13E overlap each other, to thereby identify devices 13A to 13E corresponding to the intersecting line segments 103A to 103E including the overlapping line segments 104A and 104B as device groups 105A and 105B. For example, the determination unit 202 uses a direction of separating away from the control room 12 serving as a starting point as a searching direction of the device groups 105A and 105B to continue the searching of the overlapping line segments 104A and 104B, to thereby sequentially identify the plurality of device groups 105A and 105B. In the example of FIG. 9, as a result of searching for the overlapping line segments 104A and 104B by the determination unit 202, three devices 13A to 13C corresponding to the three intersecting line segments 103A to 103C including the first overlapping line segment 104A are identified as the first device group 105A, and two devices 13D and 13E corresponding to the two intersecting line segments 103D and 103E including the second overlapping line segment 104B are identified as the second device group 105B.

At this time, the determination unit 202 may search for the overlapping line segment so that the number of devices 13 corresponding to the intersecting line segment including the overlapping line segment satisfies the terminal spare allowable value, to thereby identify the device group. In FIG. 9, for example, as the installation specification of the relay device 14, when the maximum terminal number (which may be the maximum signal connection number) of secondary terminals 141 is five and when the terminal spare allowable value is 50% in spare ratio or three in spare number, two devices 13A and 13B may be identified as the first device group, two devices 13C and 13D may be identified as the second device group, and one device 13E may be identified as a third device group.

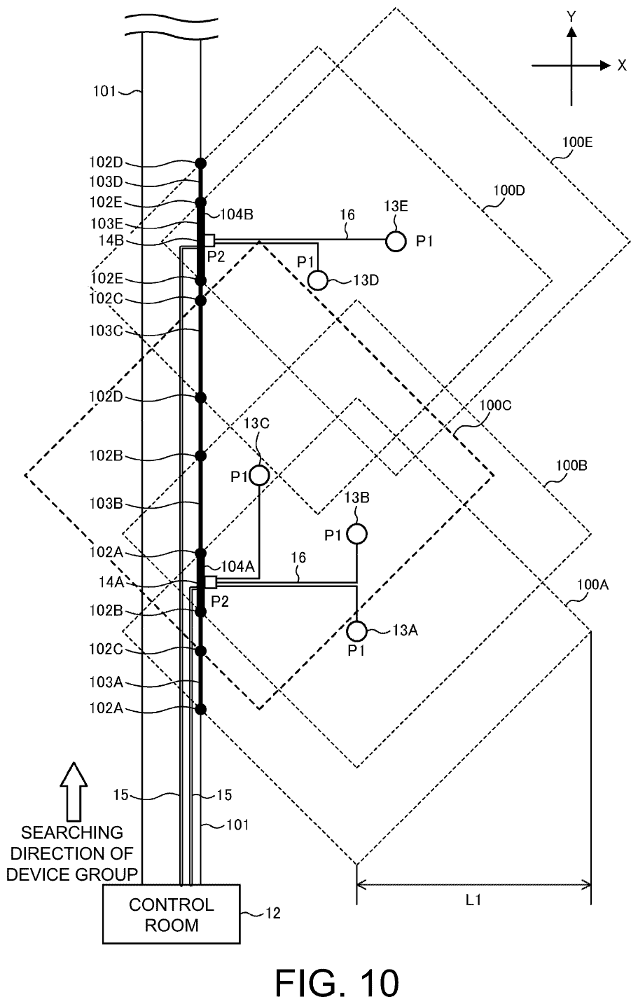

Next, as illustrated in FIG. 10, the determination unit 202 determines, for each of the first and second device groups 105A and 105B, an installation position P2 of each of first and second relay devices 14A and 14B on an inner side of each of the first and second overlapping line segments 104A and 104B. In addition, the determination unit 202 determines the allocation of the five devices 13A to 13E such that the three devices 13A to 13C corresponding to the three intersecting line segments 103A to 103C including the first overlapping line segment 104A are connected to the first relay device 14A and the two devices 13D and 13E corresponding to the two intersecting line segments 103D and 103E including the second overlapping line segment 104B are connected to the second relay device 14B. In this embodiment, description is given assuming that the installation position P2 of each of the first and second relay devices 14A and 14B is determined to be a midpoint of each of the first and second overlapping line segments 104A and 104B, but the installation position P2 may be determined to be other positions as long as the installation position P2 is on the inner side of the overlapping line segment.

At this time, the determination unit 202 may determine, for each device group, the installation specification of the relay device 14 so that the number of devices 13 corresponding to the intersecting line segment including the overlapping line segment satisfies the terminal spare allowable value. In FIG. 10, for example, as the installation specification of the relay device 14, when there are two types of maximum terminal number (which may be maximum signal connection number) of secondary terminals 141 of five and ten, and when the terminal spare allowable value is 50% in spare ratio or three in spare number, the number of devices 13A to 13C included in the first device group 105A is three, and hence the installation specification of the relay device 14 with respect to the first device group 105A is determined to a specification in which the maximum terminal number of secondary terminals 141 is ten. Further, the number of devices 13D and 13E included in the second device group 105B is two, and hence the installation specification of the relay device 14 with respect to the second device group 105B is determined to a specification in which the maximum terminal number of secondary terminals 141 is five.

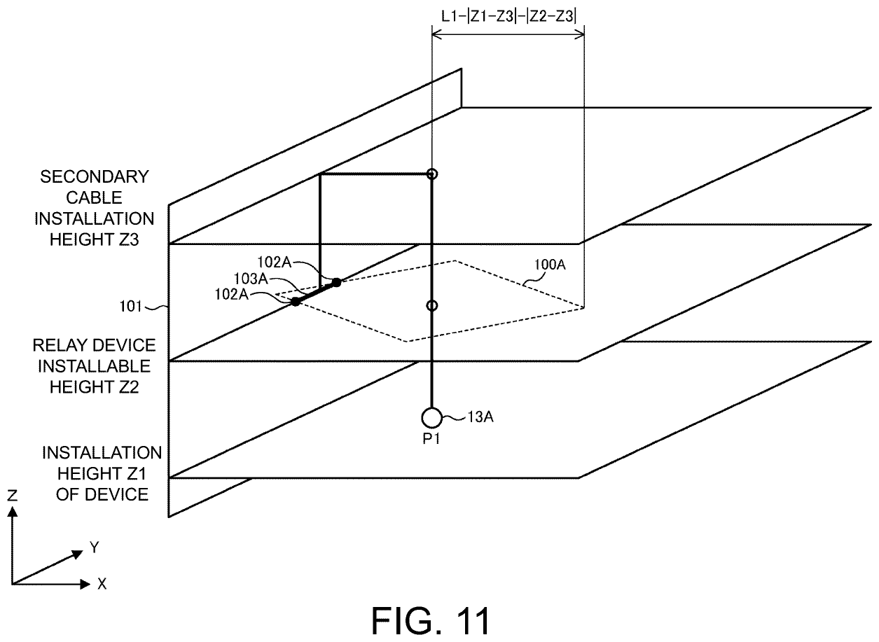

Regarding the length of the secondary cable 16, when consideration is given not only to a planar direction (X direction and Y direction) but also to a height direction (Z direction), as a second processing example (see FIG. 11 to be referred to later) of the relay device wiring design processing, the determination unit 202 may arrange, into the layout diagram of the plant 10, through use of the installation position P1 of the device 13 as a reference, an imaginary frame defined by the secondary cable upper-limit length L1, the installation height Z1 of the device 13, the relay device installable height Z2 of the relay device 14, and the secondary cable installable height Z3, for each device 13.

FIG. 11 is a function explanatory diagram for illustrating the second processing example of the relay device wiring design processing performed by the determination unit 202. The second processing example is different from the first processing example in considering the height direction (Z direction) for the length of the secondary cable 16, but other processing contents are the same. FIG. 11 shows an imaginary frame 100A for one device 13A.

When the shape of the imaginary frame 100A is a rhombus, through use of the installation position Pl of the device 13 as a center, a distance from this center to each point is defined as a value (=L1−|Z1−Z3|−|Z2−Z3|) obtained by subtracting, from the secondary cable upper-limit length L1, a subtraction value (=|Z1−Z3|) between the installation height Z1 of the device 13 and the secondary cable installable height Z3 and a subtraction value (=|Z2−Z3|) between the relay device installable height Z2 and the secondary cable installable height Z3. In this manner, the length of the secondary cable 16 required for wiring in the height direction can be reflected in the wiring design of the relay device 14.

As another processing example of the relay device wiring design processing, the determination unit 202 may determine the installation position of the relay device 14 and the allocation of the device 13 for each attribute of the signal.

For example, when the management system is considered as the attribute of the signal, the determination unit 202 determines the installation position of the relay device 14 and the allocation of the device 13 for each management system. In this embodiment, the relay device 14 is separately installed for each of the process control system, the emergency stop system, and the security system. Thus, the installation position of the relay device 14 with respect to the process control system and the allocation of the device 13 used in the process control system with respect to this relay device 14 are determined. Further, the installation position of the relay device 14 with respect to the emergency stop system and the allocation of the device 13 used in the emergency stop system with respect to this relay device 14 are determined. Still further, the installation position of the relay device 14 with respect to the security system and the allocation of the device 13 used in the security system with respect to this relay device 14 are determined.

Further, when the signal type is considered as the attribute of the signal, the determination unit 202 determines the installation position of the relay device 14 and the allocation of the device 13 for each signal type. In this embodiment, the relay device 14 is separately installed for each of a case of a digital signal and a case of an analog signal. Thus, the installation position of the relay device 14 for a digital signal and the allocation of the device 13 for transmitting and receiving a digital signal with respect to this relay device 14 are determined. Further, the installation position of the relay device 14 for an analog signal and the allocation of the device 13 for transmitting and receiving an analog signal with respect to this relay device 14 are determined.

Moreover, the determination unit 202 may determine the route of the primary cable 15 and the route of the secondary cable 16. For example, the determination unit 202 searches for a route connecting the installation position of the control room 12 and the installation position of the relay device 14 to each other so as to pass through the primary cable installation region, to thereby determine the route of the primary cable 15. The determination unit 202 searches for a route of the secondary cable 16 connecting the installation position of the relay device 14 and the device 13 connected to the relay device 14 to each other so as to satisfy the secondary cable installable height, to thereby determine the route of the secondary cable 16.

Further, when the correction reception unit 200A receives a correction instruction, the determination unit 202 corrects the installation position of the relay device 14 and the allocation of the device 13 based on this correction instruction. In this manner, the installation position of the relay device 14 and the allocation of the device 13 determined by the determination unit 202 can be regarded as tentative decisions, and final decisions can be made under a state in which the correction instruction given by the designer 30 is reflected. The correction instruction may be an instruction to further correct any one of the installation specification of the relay device 14, the route of the primary cable 15, or the route of the secondary cable 16. In this case, those pieces of information are corrected based on this correction instruction.

Moreover, when the update reception unit 200B receives the update instruction and the change prohibiting instruction, the determination unit 202 re-determines, based on the updated plant design information 50 and the updated relay device wiring design condition 60 that have been updated in response to this update instruction, the installation position of the relay device 14 and the allocation of the device 13 which do not correspond to the change prohibited range designated by this change prohibiting instruction. In this manner, after the installation position of the relay device 14 and the allocation of the device 13 are determined by the determination unit 202, for example, when a design change, such as addition, deletion, or a change, of the device 13 is performed, without starting over the entire wiring design of the relay device 14, the target of the start-over is limited only to a part not corresponding to the change prohibited range. Thus, the range to be influenced by the design change can be reduced.

The information output unit 203 registers the relay device wiring design information (for example, the installation position and the installation specification of the relay device 14, the allocation of the device 13, and the like) determined by the relay device wiring design processing performed by the determination unit 202 in the plant design information 50. Specifically, the information output unit 203 registers the installation position of the relay device 14, the route of the primary cable 15, and the route of the secondary cable 16 in the wiring design diagram 504. Further, the information output unit 203 registers the installation specification of the relay device 14 and the allocation of the device 13 connected to the relay device 14 in the wiring block diagram 503. The registration destination of the relay device wiring design information with respect to the plant design information 50 is not limited to the above-mentioned example.

Moreover, the information output unit 203 may transmit display screen information for displaying the relay device wiring design information as a display screen to the designer terminal apparatus 3, and may urge the designer 30 to check the information via this display screen. In addition, via this display screen, the correction reception unit 200A may receive the correction instruction, or the update reception unit 200B may receive the update instruction and the change prohibiting instruction.

FIG. 12 is a hardware configuration diagram for illustrating an example of a computer 900 forming each of the plant design assistance apparatus 2 and the designer terminal apparatus 3.

Each of the plant design assistance apparatus 2 and the designer terminal apparatus 3 is formed of a general-purpose or dedicated computer 900. The computer 900 includes, as illustrated in FIG. 12, as main components thereof, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a medium input/output unit 928. The above-mentioned components may be omitted as appropriate in accordance with the application in which the computer 900 is used.

The processor 912 is formed of one or a plurality of arithmetic processing units (central processing unit (CPU), micro-processing unit (MPU), digital signal processor (DSP), graphics processing unit (GPU), and the like), and operates as a control unit for controlling the overall computer 900. The memory 914 stores various types of data and a program 930, and is formed of, for example, a volatile memory (DRAM, SRAM, or the like) functioning as a main memory, and a non-volatile memory (ROM), a flash memory, or the like.

The input device 916 is formed of, for example, a keyboard, a mouse, numeric keys, or an electronic pen, and functions as an input unit. The output device 917 is formed of, for example, a sound (voice) output device or a vibration device, and functions as an output unit. The display device 918 is formed of, for example, a liquid crystal display, an organic EL display, an electronic paper display, or a projector, and functions as the output unit. The input device 916 and the display device 918 may be integrally formed like a touch panel display. The storage device 920 is formed of, for example, an HDD or an SSD, and functions as a storage unit. The storage device 920 stores various types of data required for executing the operating system or the program 930.

The communication I/F unit 922 is connected in a wired or wireless manner to a network 940 (which may be the same as the network 4 of FIG. 1), such as the Internet or an intranet, and functions as a communication unit for transmitting and receiving data to and from other computers in accordance with a predetermined communication standard. The external device I/F unit 924 is connected in a wired or wireless manner to an external device 950, such as a camera, a printer, a scanner, or a reader/writer, and functions as a communication unit for transmitting and receiving data to and from the external device 950 in accordance with a predetermined communication standard. The I/O device I/F unit 926 is connected to an I/O device 960, such as various sensors or actuators, and functions as a communication unit for transmitting and receiving, for example, various signals, such as a detection signal obtained by a sensor or a control signal output to an actuator, and data to and from the I/O device 960. The medium input/output unit 928 is formed of, for example, a drive device, such as a digital versatile disc (DVD) drive or a compact disc (CD) drive, a memory card slot, or a USB connector, and reads data from or writes data to a medium (non-transitory storage medium) 970, such as a DVD, a CD, a memory card, or a USB memory.

In the computer 900 having the above-mentioned configuration, the processor 912 invokes the program 930 stored in the storage device 920 into the memory 914 to execute the program 930, to thereby control each unit of the computer 900 via the bus 910. The program 930 may be stored in the memory 914 instead of being stored in the storage device 920. The program 930 may be stored in the medium 970 in an installable file format or an executable file format, and may be provided to the computer 900 via the medium input/output unit 928. The program 930 may be provided to the computer 900 by being downloaded via the network 940 through the communication I/F unit 922. Further, the computer 900 may implement various functions to be implemented by the processor 912 executing the program 930 by, for example, hardware, such as a field-programmable gate array (FPGA) or an application specific integrated circuit (ASIC).

The computer 900 is formed of, for example, a stationary-type computer or a portable-type computer, and is an electronic device in any mode. The computer 900 may be a client-type computer, a server-type computer, or a cloud-type computer.

### Operation of Plant Design Assistance System 1

Now, a series of operations performed by the plant design assistance system 1 is described. The series of operations is executed by each unit of the plant design assistance apparatus 2 (each step of a plant designing method executed by the plant design assistance program 210) and the designer terminal apparatus 3 cooperating with each other.

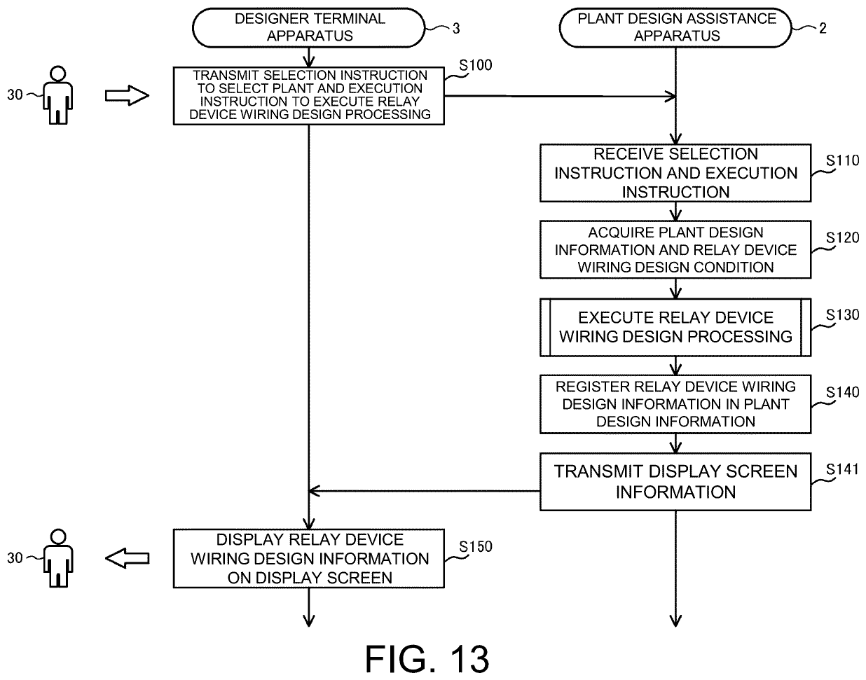

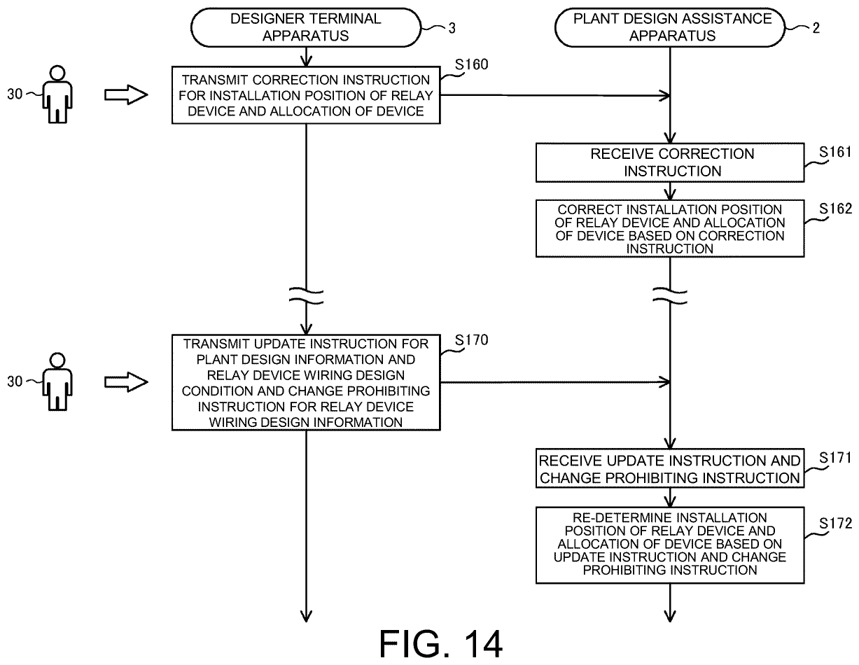

FIG. 13 and FIG. 14 are flow charts for illustrating an example of the operation of the plant design assistance system 1. In the following, description is given assuming that the information of the plant design database 5 and the design condition database 6 has been registered in advance.

First, in Step S100, when the designer terminal apparatus 3 receives, for example, as an input operation performed by the designer 30 on the display screen, a selection instruction to select the plant 10 that becomes a target of the wiring design of the relay device 14 and an execution instruction to execute the relay device wiring design processing, the designer terminal apparatus 3 transmits instruction information on the selection instruction and the execution instruction to the plant design assistance apparatus 2.

Next, in Step S110, the instruction reception unit 200 of the plant design assistance apparatus 2 receives this instruction information to receive the selection instruction and the execution instruction.

Next, in Step S120, the information acquisition unit 201 refers to the plant design database 5 and the design condition database 6 to acquire the plant design information 50 and the relay device wiring design condition 60 relating to the selection instruction and the execution instruction received in Step S110.

Next, in Step S130, the determination unit 202 performs the relay device wiring design processing based on the plant design information 50 and the relay device wiring design condition 60 acquired in Step S120.

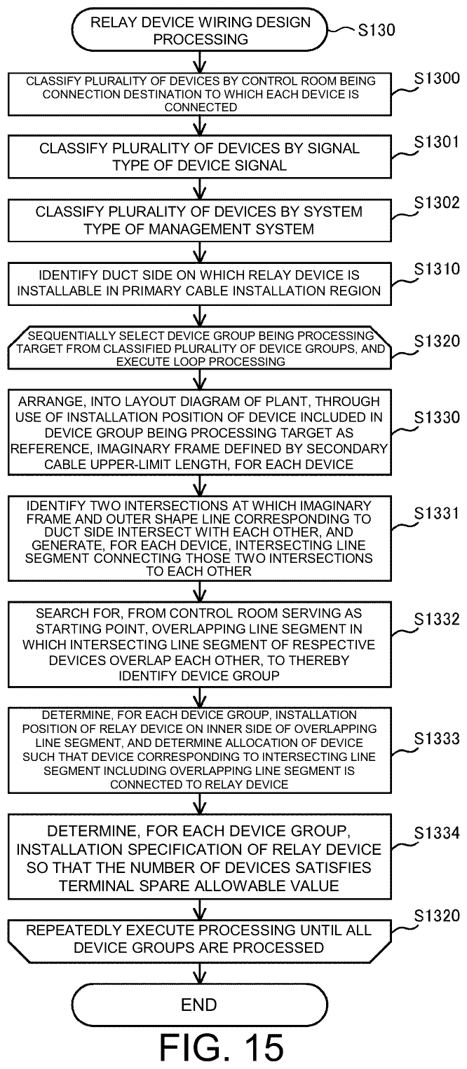

FIG. 15 is a flow chart for illustrating details of the relay device wiring design processing (Step S130) performed by the determination unit 202. First, in Step S1300, the determination unit 202 classifies the plurality of devices 13 by control room 12 being a connection destination to which each device 13 is connected. When the number of control rooms 12 is one, Step S131 is omitted. Next, in Step S1301, the plurality of devices 13 are classified by signal type (analog signal or digital signal) of the device signal, and, in Step S1302, the plurality of devices 13 are classified by system type (process control system, emergency stop system, or security system) of the management system. In the relay device wiring design condition 60, when a design request of disabling allocation to the same relay device 14 is further set, a step of classifying the plurality of devices 13 based on this design request may be further added.

Next, in Step S1310, in the primary cable installation region, a duct side on which the relay device 14 is installable (corresponding to the outer shape line 101 of FIG. 8 to FIG. 10) is identified. The position of the duct side may be received from the designer terminal apparatus 3 as an input operation performed by the designer 30.

Then, in Step S1320, the determination unit 202 sequentially selects, from a plurality of device groups classified in each of Step S1300 to Step S1302, a device group serving as a processing target, and performs loop processing of repeating Step S1330 to Step S1334 to determine, for each of the device groups, the installation position and the installation specification of the relay device 14 and the allocation of the device 13 connected to the relay device 14. Description is given here of a case in which the first processing example (see FIG. 8 to FIG. 10) is applied to Step S1330 to Step S1334, but the second processing example may be applied thereto.

In Step S1330, as illustrated in FIG. 8, the determination unit 202 arranges, into the layout diagram of the plant 10, through use of the installation position PI of the device 13 included in the device group serving as the processing target as a reference, for example, a rhombus-shaped imaginary frame 100 (100A to 100E) defined by the secondary cable upper-limit length L1, for each device 13.

Next, in Step S1331, the determination unit 202 identifies two intersections 102 (102A to 102E) at which the imaginary frame 100 and the outer shape line 101 corresponding to the duct side in the primary cable installation region intersect with each other, and generates, for each device 13, an intersecting line segment 103 (103A to 103E) connecting those two intersections 102 to each other.

Next, in Step S1332, as illustrated in FIG. 9, the determination unit 202 searches for, from the control room 12 serving as a starting point, the overlapping line segment 104 (104A and 104B) in which the intersecting line segments 103 of the respective devices 13 overlap each other, to thereby identify the device 13 corresponding to the intersecting line segment 103 including the overlapping line segment 104 as the device group 105 (105A and 105B).

Next, in Step S1333, as illustrated in FIG. 10, the determination unit 202 determines, for each device group 105, the installation position P2 of the relay device 14 on the inner side of the overlapping line segment 104 (in this embodiment, at the midpoint of the overlapping line segment 104), and determines the allocation of the device 13 such that the device 13 corresponding to the intersecting line segment 103 including the overlapping line segment 104 is connected to the relay device 14.

Next, in Step S1334, the determination unit 202 determines, for each device group 105, the installation specification of the relay device 14 so that the number of devices 13 corresponding to the intersecting line segment 103 including the overlapping line segment 104 satisfies the terminal spare allowable value.

Then, the loop processing in Step S1320 is performed so that, for each device group classified by each control room, each signal type, and each system type, the installation position and the installation specification of each relay device 14 and the allocation of the device 13 to each relay device 14 are determined, and a series of steps of the relay device wiring design processing illustrated in FIG. 15 is ended.

Next, in Step S140 illustrated in FIG. 13, the information output unit 203 registers the relay device wiring design information (for example, the installation position and the installation specification of the relay device 14 and the allocation of the device 13) determined in the relay device wiring design of Step S130 in the plant design information 50. Then, in Step S141, the information output unit 203 transmits display screen information for displaying this relay device wiring design information as a display screen to the designer terminal apparatus 3. At this time, the information output unit 203 may calculate a total value of the number of relay devices 14 to be installed, a total value of the number of primary cables 15 and the number of secondary cables 16, a cable length of each of the primary cable 15 and the secondary cable 16, and a total value obtained by summing up each cable length, and may cause the relay device wiring design information or the display screen information to include results of the calculation.

Next, in Step S150, when the designer terminal apparatus 3 receives this display screen information, the designer terminal apparatus 3 displays the relay device wiring design information on the display screen based on this display screen information.

Then, in Step S160 illustrated in FIG. 14, when a correction instruction to correct part of information of at least one of the installation position of the relay device 14 or the allocation of the device 13 is input to the designer terminal apparatus 3 as an input operation performed by the designer 30 who has checked the relay device wiring design information, in Step S161, the correction reception unit 200A receives this correction instruction. Next, in Step S162, the determination unit 202 corrects the installation position of the relay device 14 and the allocation of the device 13 based on this correction instruction. Then, the corrected relay device wiring design information is registered in the plant design information 50 by the information output unit 203, similarly to Step S140.

Further, in Step S170, when an update instruction to update part of information of at least one of the plant design information 50 or the relay device wiring design condition 60 and a change prohibiting instruction to designate the change prohibited range in which the change of information is prohibited in the relay device wiring design information are input as an input operation performed by the designer 30 who has checked the relay device wiring design information, in Step S171, the update reception unit 200B receives the update instruction and the change prohibiting instruction. Then, in Step S172, the determination unit 202 re-determines, based on the update instruction and change the prohibiting instruction, the installation position of the relay device 14 and the allocation of the device 13 that do not correspond to the change prohibited range designated by this change prohibiting instruction based on the updated plant design information 50 and the updated relay device wiring design condition 60. Then, the re-determined relay device wiring design information is registered in the plant design information 50 by the information output unit 203, similarly to Step S140. Further, similarly to Step S141, display screen information for displaying this re-determined relay device wiring design information as a display screen may be transmitted by the information output unit 203 to the designer terminal apparatus 3.

In the above-mentioned series of steps of processing, Step S110, Step S161, and Step S171 correspond to an instruction reception step, Step S120 corresponds to an information acquisition step, Step S130, Step S162, and Step S172 correspond to a determination step, and Step S140 corresponds to an information output step.

As described above, according to the plant design assistance apparatus 2, the determination unit 202 determines the installation position of the relay device 14 in the layout diagram and the allocation of the device 13 connected to the relay device 14 based on the plant design information 50 and the relay device wiring design condition 60, and hence the wiring design of the relay device 14 can be appropriately carried out without requiring many experiences in construction sites or advanced design skills.

### Other Embodiments

The present invention is not limited to the above-mentioned embodiment, and various modifications can be made without departing from the gist of the present invention. Further, all of the embodiments thus obtained are included in the technical idea of the present invention.

In the above-mentioned embodiment, description has been given assuming that the function of each unit included in the plant design assistance apparatus 2 is implemented by one apparatus, but the function of each unit may be distributed to a plurality of apparatus to be implemented by the plurality of apparatus. Further, the control unit of the designer terminal apparatus 3 may execute the plant design assistance program 210 to function as the plant design assistance apparatus 2.

In the above-mentioned embodiment, description has been given of a case in which the plant design assistance system 1 operates in accordance with the flow charts of FIG. 13 to FIG. 15, but the execution order of each step may be changed as appropriate, or some of the steps may be omitted.

In the above-mentioned embodiment, description has been given assuming that the plant design assistance apparatus 2 performs the relay device wiring design processing for one relay device wiring design condition 60, but the plant design assistance apparatus 2 may perform the relay device wiring design processing for each of a plurality of relay device wiring design conditions 60 (for example, conditions obtained by changing the secondary cable upper-limit length and the terminal spare allowable value). In this case, the plant design assistance apparatus 2 may output a plurality of pieces of relay device wiring design information each determined in the relay device wiring design processing to the designer 30 so that the designer 30 can perform comparison and examination, or the plant design assistance apparatus 2 may compare the plurality of pieces of relay device wiring design information each determined in the relay device wiring design processing with a predetermined reference (for example, the total value of the number of relay devices 14 to be installed, the total number of primary cables 15 and secondary cables 16, each cable length, and the total value of each cable length) so that the optimum relay device wiring design information is output.

In the above-mentioned embodiment, detailed processing contents have been described for the relay device wiring design processing (Step S130) performed by the determination unit 202, but the processing contents may be changed as appropriate. Now, a first modification example to a sixth modification example of the relay device wiring design processing are described.

### First Modification Example

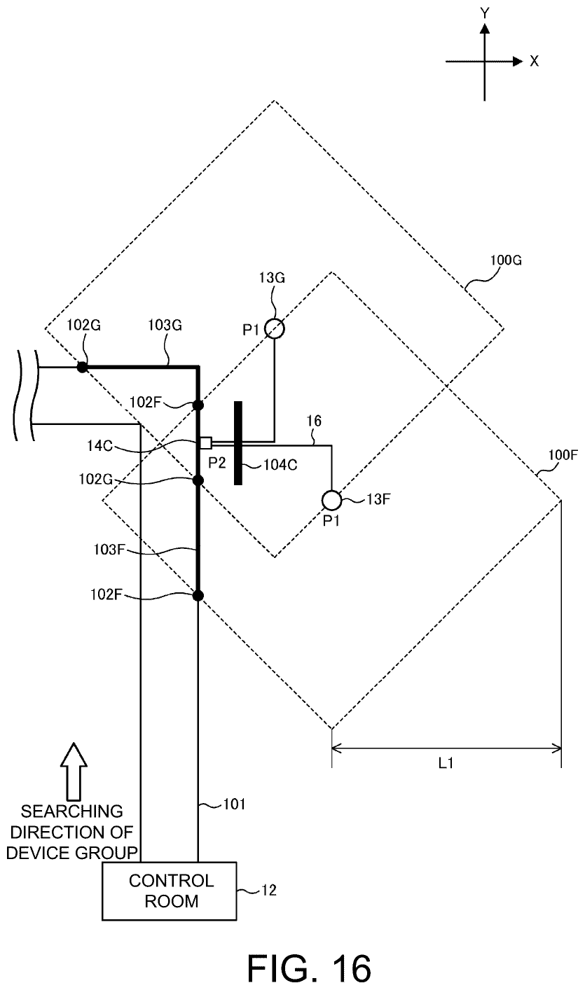

FIG. 16 is a function explanatory diagram for illustrating a first modification example of the relay device wiring design processing. In the first modification example, in Step S1331, when the determination unit 202 generates, for each device 13, the intersecting line segment 103 by connecting between the two intersections 102 at which the outer shape line 101 of the primary cable installation region and the imaginary frame 100 intersect with each other, as in devices 13F and 13G illustrated in FIG. 16, intersecting line segments 103F and 103G are generated along the outer shape line 101 of the primary cable installation region. Accordingly, as illustrated in FIG. 16, the intersecting line segment 103G for the device 13G is generated into a bent-line shape by connecting two intersections 102G to each other along a corner part of the outer shape line 101. When the outer shape line 101 has a curved part, the intersecting line segment 103 may be generated into a curved shape. Further, in the example of FIG. 16, an overlapping line segment 104C is generated into a linear shape, but, when a plurality of intersecting line segments 103 overlap each other in a corner part or a curved part, the overlapping line segment 104C may also be generated into a bent-line shape or a curved shape.

In this manner, in the plot plan diagram 500, even when, as in the device 13G illustrated in FIG. 16, the primary cable installation region is absent in the up-down direction and the right-left direction of the device 13G, the intersecting line segment 103G is generated along the outer shape line 101 of the primary cable installation region, and thus an installation position P2 of a relay device 14C for the device 13G is determined. Thus, in the plot plan diagram 500, the degree of freedom of the installation position of the device 13 can be improved.

### Second Modification Example

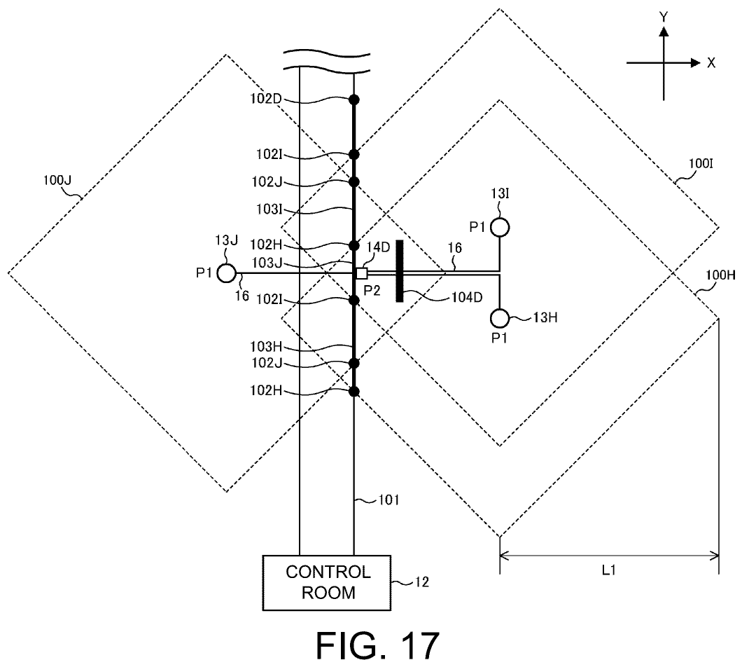

FIG. 17 is a function explanatory diagram for illustrating a second modification example of the relay device wiring design processing. In the above-mentioned embodiment, description has been given assuming that, in Step S1331, the intersecting line segment 103 is generated by connecting between two intersections 102 at which the outer shape line 101 of the primary cable installation region and the imaginary frame 100 intersect with each other. At this time, the intersecting line segment 103 may be generated on the same side as the device 13 by connecting between intersections (intersections on the same side) at which the outer shape line 101 of the primary cable installation region positioned on the same side as the device 13 and the imaginary frame 100 intersect with each other, or the intersecting line segment 103 may be generated on a side opposite to the device 13 by connecting between intersections (intersections on the opposite side) at which the outer shape line 101 of the primary cable installation region positioned on the side opposite to the device 13 and the imaginary frame 100 intersect with each other. As a result, the installation position P2 of the relay device 14 may be determined on the same side as the primary cable installation region with respect to the device 13, or may be determined on the side opposite to the primary cable installation region with respect to the device 13.

In the second modification example, a medium device connection setting indicating whether or not to allow a device 13 to be connected to a relay device 14 positioned on the opposite side of the primary cable installation region with respect to the device 13 is recorded in the relay device wiring design condition 60. In addition, when the medium device connection setting allows connection to the opposite side of the primary cable installation region, the determination unit 202 determines the installation position of the relay device 14 and the allocation of the device 13 so that the device 13 is connected to the relay device 14 positioned on the same side or the opposite side of the primary cable installation region with respect to the device 13. Further, when the medium device connection setting does not allow the connection to the opposite side of the primary cable installation region, the determination unit 202 determines the installation position of the relay device 14 and the allocation of the device 13 so that the device 13 is connected only to the relay device 14 positioned on the same side of the primary cable installation region with respect to the device 13.

For example, when the medium device connection setting allows the connection to the opposite side of the primary cable installation region, as illustrated in FIG. 17, the determination unit 202 generates an intersecting line segment 103J on a side opposite to a device 13J by connecting between two intersections 102J at which the outer shape line 101 of the primary cable installation region positioned on the side opposite to the device 13J and the imaginary frame 100 intersect with each other. In this manner, as illustrated in FIG. 17, the device 13J is allocated so as to be connected to a relay device 14D positioned on the opposite side of the primary cable installation region. In addition, the secondary cable 16 for the device 13J is installed so as to cross the primary cable installation region. Thus, the number of relay devices 14 to be installed can be reduced.

### Third Modification Example

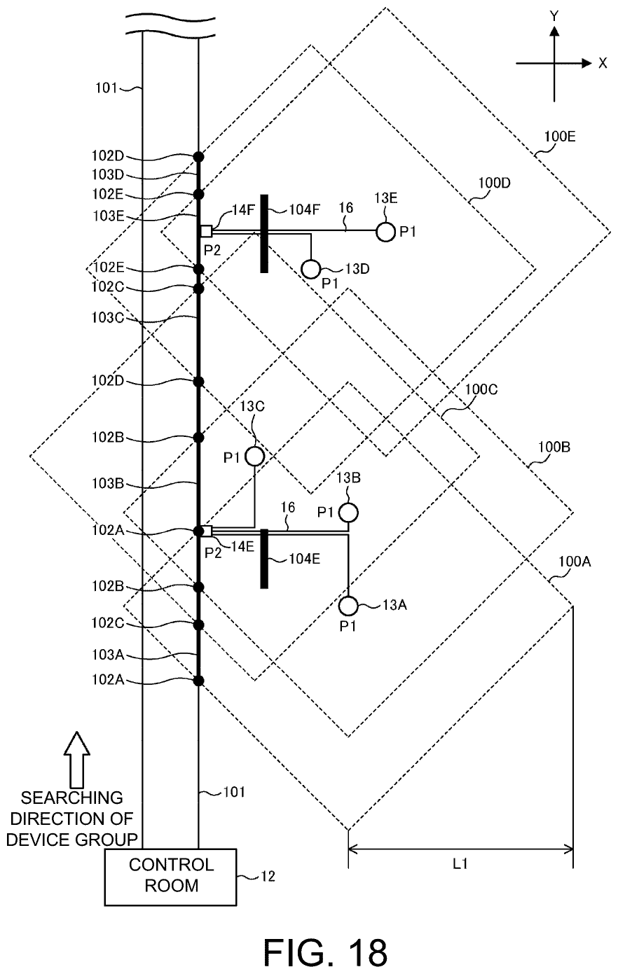

FIG. 18 is a function explanatory diagram for illustrating a third modification example of the relay device wiring design processing. In the third modification example, in Step S1333, when the determination unit 202 determines, for each device group 105, the installation position P2 of the relay device 14 on the inner side of the overlapping line segment 104, the determination unit 202 determines the installation position P2 of the relay device 14 based on a total value obtained by summing up the length of the secondary cable 16 at the time when the plurality of devices 13 included in the device group 105 are each connected to the relay device 14. Accordingly, an installation position P2 of a relay device 14E for the devices 13A to 13C illustrated in FIG. 18 is located on the device 13C side as compared to the installation position P2 of the relay device 14A illustrated in FIG. 10 (midpoint of the overlapping line segment 104A). The determination unit 202 may determine the installation position P2 of the relay device 14 so that the total value obtained by summing up each cable length of the secondary cable 16 becomes shorter. Moreover, the determination unit 202 may determine the installation position P2 of the relay device 14 so that this total value becomes a minimum value.

In this manner, the installation position P2 of the relay device 14 is determined in consideration of the total value obtained by summing up each cable length of the secondary cable 16. Thus, the usage amount of the entire secondary cable 16 can be reduced.

### Fourth Modification Example

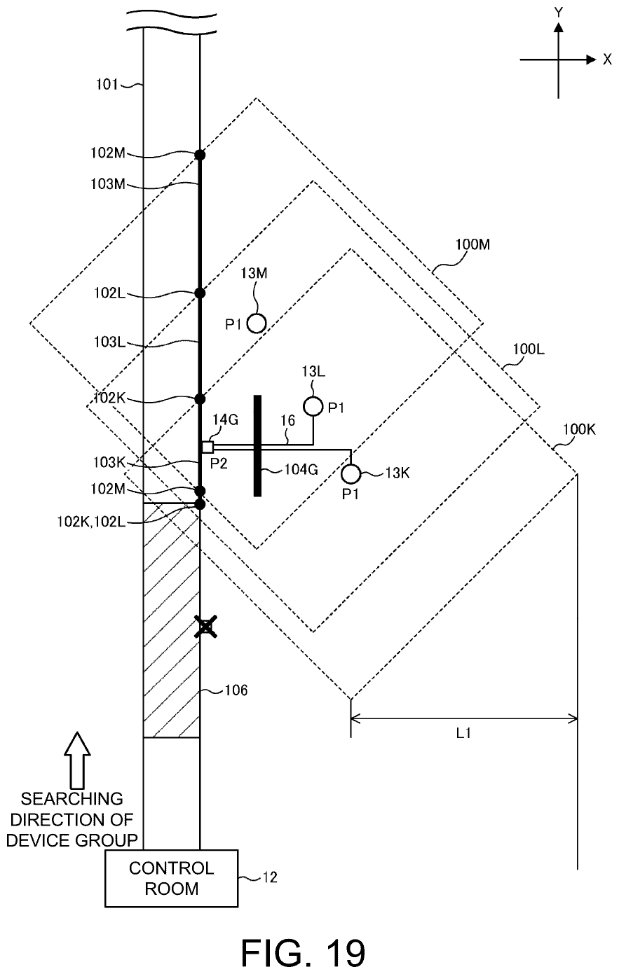

FIG. 19 is a function explanatory diagram for illustrating a fourth modification example of the relay device wiring design processing. In the fourth modification example, a relay device installation prohibited region 106 indicating, within the primary cable installation region, a region in which the relay device 14 is prohibited to be installed is stored in, for example, the plot plan diagram 500. In addition, the determination unit 202 determines the installation position P2 of the relay device 14 for a primary cable installation region excluding this relay device installation prohibited region 106.

Specifically, in Step S1331, when the determination unit 202 generates the intersecting line segment 103 for each device 13, as illustrated in FIG. 19, the determination unit 202 identifies two intersections 102K to 102M at which the outer shape line 101 of the primary cable installation region excluding the relay device installation prohibited region 106 and each of imaginary frames 100K to 100M intersect with each other, and generates intersecting line segments 103K to 103M each connecting those two intersections 102K to 102M to each other. In the example of FIG. 19, the intersecting line segments 103K and 103L for the devices 13K and 13L are generated with a restriction of up to an end portion of the relay device installation prohibited region 106 (intersections 102K and 102L).

In this manner, as illustrated in FIG. 19, an overlapping line segment 104G overlapping the intersecting line segments 103K and 103L is searched for so as not to include the relay device installation prohibited region 106, and hence an installation position P2 of a relay device 14G is determined so as to avoid the relay device installation prohibited region 106. Thus, for example, a region in which the primary cable 15 is buried underground can be treated as the relay device installation prohibited region 106 so that the installation position P2 of the relay device 14 can be prevented from being determined to be within such a relay device installation prohibited region 106.

### Fifth Modification Example

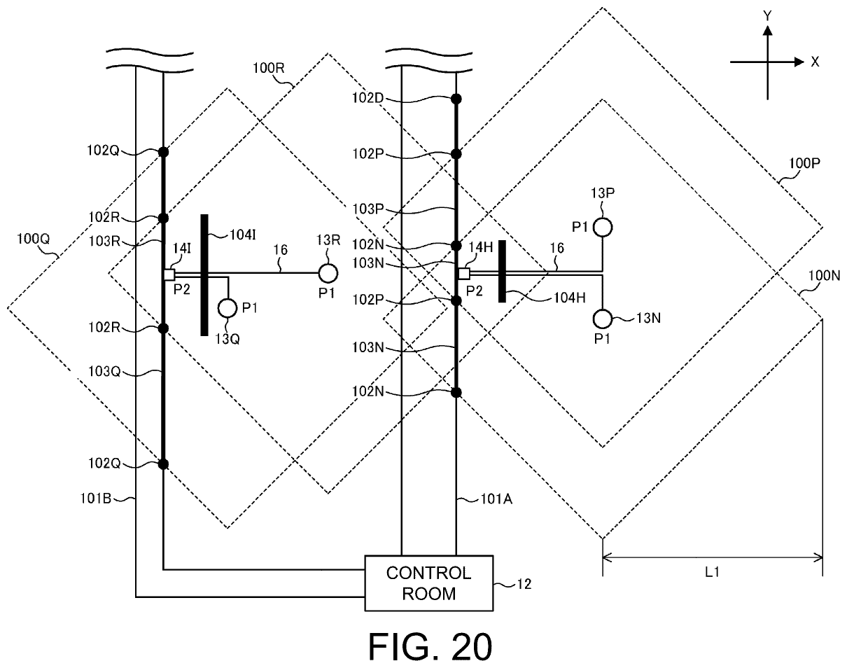

FIG. 20 is a function explanatory diagram for illustrating a fifth modification example of the relay device wiring design processing. In the above-mentioned embodiment, as another processing example, description has been given assuming that the determination unit 202 determines the installation position P2 of the relay device 14 and the allocation of the device 13 for each attribute of the signal. In the fifth modification example, an installation allowing signal attribute indicating the attribute of the signal which allows installation to the primary cable installation region is recorded in, for example, the plot plan diagram 500. In addition, the determination unit 202 determines the installation position P2 of the relay device 14 and the allocation of the device 13 so that the primary cable 15 corresponding to the attribute of the signal indicated by the installation allowing signal attribute set for the primary cable installation region is installed in this primary cable installation region.

For example, when the management system is considered as the attribute of the signal, the determination unit 202 determines an installation position P2 of a relay device 14H for the process control system so that devices 13N and 13P used in the process control system are connected by the secondary cables 16 to a primary cable installation region (outer shape line 101A) in which the process control system is set as the installation allowing signal attribute. In addition, the determination unit 202 determines an installation position P2 of a relay device 141 for the emergency stop system so that devices 13Q and 13R used in the emergency stop system are connected by the secondary cables 16 to a primary cable installation region (outer shape line 101B) in which the emergency stop system is set as the installation allowing signal attribute.

Further, when the signal type is considered as the attribute of the signal, the determination unit 202 determines the installation position P2 of the relay device 14H for a digital signal so that the devices 13N and 13P for transmitting and receiving a digital signal are connected by the secondary cables 16 to the primary cable installation region (outer shape line 101A) in which a device for a digital signal is set as the installation allowing signal attribute. In addition, the determination unit 202 determines the installation position P2 of the relay device 141 for an analog signal so that the devices 13Q and 13R for transmitting and receiving an analog signal are connected by the secondary cables 16 to the primary cable installation region (outer shape line 101A) in which a device for an analog signal is set as the installation allowing signal attribute.

In this manner, the installation position P2 of the relay device 14 and the allocation of the device 13 are determined so that the primary cable 15 corresponding to a specific attribute of a signal set by the installation allowing signal attribute is installed in the primary cable installation region. Thus, it is possible to prevent the relay device 14 corresponding to an attribute of a signal different from the installation allowing signal attribute from being installed with respect to the primary cable installation region in which the installation allowing signal attribute is set, or prevent the device 13 from being allocated to this relay device 14.

### Sixth Modification Example

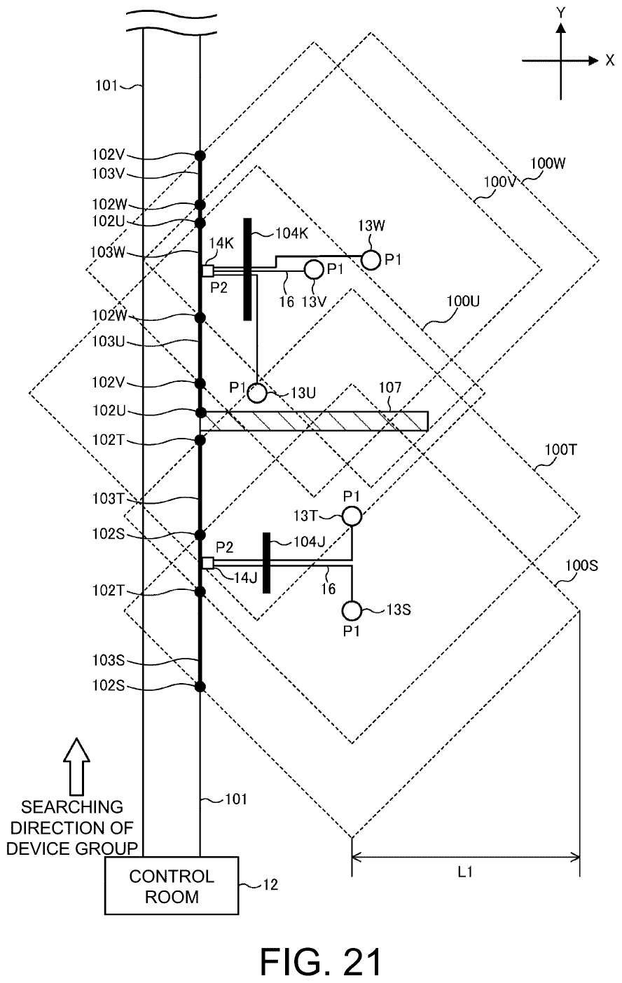

FIG. 21 is a function explanatory diagram for illustrating a sixth modification example of the relay device wiring design processing. In the sixth modification example, a secondary cable installation prohibited region 107 indicating a region in which the secondary cable 16 is prohibited to be installed is recorded in, for example, the plot plan diagram 500. In addition, the determination unit 202 determines the installation position P2 of the relay device 14 so that the secondary cable 16 is prevented from passing through the secondary cable installation prohibited region 107.

Specifically, in Step S1331, when the determination unit 202 generates the intersecting line segment 103 for each device 13, the determination unit 202 excludes, from the intersecting line segment 103, a line segment passing through the secondary cable installation prohibited region 107 when the secondary cable 16 is installed, to thereby generate intersecting line segments 103S to 103V. In the example of FIG. 21, an intersecting line segment 103U for a device 13U is restricted to up to an end portion of the secondary cable installation prohibited region 107 (intersection 102U).

In this manner, as illustrated in FIG. 21, an overlapping line segment 104K overlapping the intersecting line segment 103U is searched for so as not to overlap the secondary cable installation prohibited region 107, and hence a route at the time of installing the secondary cable 16 for the device 13U is determined so as to avoid the secondary cable installation prohibited region 107. Thus, for example, when an obstacle that inhibits installation of the secondary cable 16 is present or when a plurality of devices 13 close to each other are separately connected to two relay devices 14 so that the plurality of devices 13 are prevented from being connected to the same relay device 14, an actual obstacle or an imaginary obstacle can be treated as the secondary cable installation prohibited region 107 so that the route of the secondary cable 16 can be prevented from being determined to pass through such a secondary cable installation prohibited region 107.

### REFERENCE SIGNS LIST

1 . . . plant design assistance system, 2 . . . plant design assistance apparatus, 3 . . . designer terminal apparatus, 4 . . . network, 5 . . . plant design database, 6 . . . design condition database, 10 . . . plant, 11 . . . facility, 12 . . . control room, 13, 13A to 13W . . . device, 14, 14A to 14K . . . relay device, 15 . . . primary cable, 16 . . . secondary cable, 20 . . . control unit, 21 . . . storage unit, 22 . . . communication unit, 23 . . . input unit, 24 . . . display unit, 50 . . . plant design information, 51 . . . component master information, 60 . . . relay device wiring design condition, 100A to 100W . . . imaginary frame, 101 . . . outer shape line, 102A to 102W . . . intersection, 103A to 103W . . . intersecting line segment, 104A to 104K . . . overlapping line segment, 105A, 105B . . . device group, 106 . . . relay device installation prohibited region, 107 . . . secondary cable installation prohibited region, 140 . . . primary terminal, 141 . . . secondary terminal, 200 . . . instruction reception unit, 200A . . . correction reception unit, 200B . . . update reception unit, 201 . . . information acquisition unit, 202 . . . determination unit, 203 . . . information output unit, 210 . . . plant design assistance program, 500 . . . plot plan diagram, 501 . . . P&ID diagram, 502 . . . I/O list, 503 . . . wiring block diagram, 504 . . . wiring design diagram

1. A plant design assistance apparatus for assisting in wiring design of a plurality of relay devices each serving as a relay between a primary cable to be connected to a control room installed in a plant and a plurality of secondary cables to be connected to a plurality of devices, respectively, the plurality of devices being installed in the plant, the plant design assistance apparatus comprising:
an information acquisition unit configured to:
acquire, as plant design information, an installation position of the control room, an installation position of each of the plurality of devices, and a primary cable installation region indicating a region in which the primary cable is installable, in a layout diagram of the plant; and
acquire a relay device wiring design condition regarding the wiring design of the plurality of relay devices; and
a determination unit configured to determine an installation position of a relay device in the layout diagram and allocation of a device connected to the relay device, based on the plant design information and the relay device wiring design condition acquired by the information acquisition unit.

2. The plant design assistance apparatus according to claim 1,
wherein the relay device wiring design condition includes a secondary cable upper-limit length indicating an upper-limit value of a length of each of the plurality of secondary cables, and
wherein the determination unit is configured to:
arrange, into the layout diagram, through use of the installation position of each of the plurality of devices as a reference, an imaginary frame defined by the secondary cable upper-limit length, for each of the plurality of devices;
generate, for each of the plurality of devices, an intersecting line segment connecting intersections between the imaginary frame and an outer shape line of the primary cable installation region to each other, and further search for, from the control room serving as a starting point, an overlapping line segment in which intersecting line segments of the plurality of devices overlap each other, to thereby identify a device corresponding to the intersecting line segment including the overlapping line segment as a device group; and
determine, for each device group, the installation position of the relay device on an inner side of the overlapping line segment, and further determine the allocation of the device such that the device corresponding to the intersecting line segment including the overlapping line segment is connected to the relay device.

3. The plant design assistance apparatus according to claim 2,
wherein the plant design information includes an installation height of each of the plurality of devices, a relay device installable height indicating a height at which each of the plurality of relay devices is installable, and a secondary cable installable height indicating a height at which each of the plurality of secondary cables is installable, and
wherein the determination unit is configured to arrange, into the layout diagram, through use of the installation position of each of the plurality of devices as a reference, the imaginary frame defined by the secondary cable upper-limit length, the installation height of each of the plurality of devices, the relay device installable height, and the secondary cable installable height, for each of the plurality of devices.

4. The plant design assistance apparatus according to claim 2,
wherein the relay device wiring design condition includes a terminal spare allowable value indicating an allowable value of a spare ratio or a spare number of terminals of each of the plurality of relay devices to which the plurality of secondary cables are connected, and
wherein the determination unit is configured to identify the device group by searching for the overlapping line segment so that the number of devices corresponding to the intersecting line segment including the overlapping line segment satisfies the terminal spare allowable value.

5. The plant design assistance apparatus according to claim 2,
wherein the relay device wiring design condition includes a terminal spare allowable value indicating an allowable value of a spare ratio or a spare number of terminals of each of the plurality of relay devices to which the plurality of secondary cables are connected, and
wherein the determination unit is configured to determine, for each device group, an installation specification of each of the plurality of relay devices so that the number of devices corresponding to the intersecting line segment including the overlapping line segment satisfies the terminal spare allowable value.

6. The plant design assistance apparatus according to claim 2,
wherein the determination unit is configured to determine, when determining the installation position of the relay device on the inner side of the overlapping line segment for each device group, the installation position of the relay device based on a total value obtained by summing up the length of each of the plurality of secondary cables when a plurality of devices included in the device group are each connected to the relay device.

7. The plant design assistance apparatus according to claim 2,
wherein the plant design information includes a relay device installation prohibited region indicating, within the primary cable installation region, a region in which the relay device is prohibited to be installed, and
wherein the determination unit is configured to connect, when generating the intersecting line segment for each of the plurality of devices, intersections between the imaginary frame and an outer shape line of the primary cable installation region excluding the relay device installation prohibited region to each other, to thereby generate the intersecting line segment.

8. The plant design assistance apparatus according to claim 2,
wherein the plant design information includes a secondary cable installation prohibited region indicating a region in which the plurality of secondary cables are prohibited to be installed, and p1 wherein the determination unit is configured to exclude, when generating the intersecting line segment for each of the plurality of devices, from the intersecting line segment, a line segment passing through the secondary cable installation prohibited region when the plurality of secondary cables are installed, to thereby generate the intersecting line segment.

9. The plant design assistance apparatus according to claim 1,
wherein the plant design information includes, as an attribute of a signal to be transmitted and received between the control room and the device, at least one of a system type or a signal type, the system type specifying in which management system among a plurality of management systems configured to manage the plant the device is to be used, the signal type specifying whether the signal is an analog signal or a digital signal, and
wherein the determination unit is configured to determine the installation position of the relay device and the allocation of the device connected to the relay device for each attribute of the signal.

10. The plant design assistance apparatus according to claim 9,
wherein the plant design information includes an installation allowing signal attribute indicating an attribute of the signal which allows installation to the primary cable installation region, and
wherein the determination unit is configured to determine the installation position of the relay device and the allocation of the device connected to the relay device so that the primary cable corresponding to the attribute of the signal indicated by the installation allowing signal attribute set for the primary cable installation region is installed in the corresponding primary cable installation region.

11. The plant design assistance apparatus according to claim 1, further comprising:
a correction reception unit configured to receive a correction instruction to correct part of information of at least one of the installation position of the relay device or the allocation of the device determined by the determination unit,
wherein the determination unit is configured to correct the installation position of the relay device and the allocation of the device based on the correction instruction received by the correction reception unit.

12. The plant design assistance apparatus according to claim 1, further comprising:
an update reception unit configured to receive an update instruction and a change prohibiting instruction, the update instruction being given to update part of information of at least one of the plant design information or the relay device wiring design condition, the change prohibiting instruction being given to designate a change prohibited range for prohibiting a change of information of at least one of the installation position of the relay device or the allocation of the device determined by the determination unit,
wherein the determination unit is configured to re-determine, when at least one of the plant design information or the relay device wiring design condition is updated in response to the update instruction received by the update reception unit, the installation position of the relay device and the allocation of the device which do not correspond to the change prohibited range designated by the change prohibiting instruction received by the update reception unit, based on the updated plant design information and the updated relay device wiring design condition.

13. The plant design assistance apparatus according to claim 1,
wherein the determination unit is configured to further determine:
a route of the primary cable connecting the control room and each of the plurality of relay devices to each other; and
a route of each of the plurality of secondary cables connecting a corresponding one of the plurality of devices and a corresponding one of the plurality of relay devices to each other.

14. The plant design assistance apparatus according to claim 1,
wherein the relay device wiring design condition includes a medium relay device connection setting indicating whether to allow a device to be connected to the relay device positioned on an opposite side of the primary cable installation region with respect to the device, and
wherein the determination unit is configured to:
determine, when the medium relay device connection setting allows connection to the relay device positioned on the opposite side, the installation position of the relay device and the allocation of the device connected to the relay device so that the device is connected to the relay device positioned on the same side or on the opposite side of the primary cable installation region with respect to the device; and
determine, when the relay device connection setting does not allow the connection to the relay device positioned on the opposite side, the installation position of the relay device and the allocation of the device connected to the relay device so that the device is connected only to the relay device on the same side.

15. A plant design assistance method of assisting in, through use of a computer, wiring design of a plurality of relay devices serving as a relay between a primary cable to be connected to a control room installed in a plant and a plurality of secondary cables to be connected to a plurality of devices, respectively, the plurality of devices being installed in the plant, the plant design assistance method comprising:
an information acquisition step of acquiring, as plant design information, an installation position of the control room, an installation position of each of the plurality of devices, and a primary cable installation region indicating a region in which the primary cable is installable, in a layout diagram of the plant, and acquiring a relay device wiring design condition regarding the wiring design of the plurality of relay devices; and
a determination step of determining an installation position of a relay device in the layout diagram and allocation of a device connected to the relay device, based on the plant design information and the relay device wiring design condition acquired in the information acquisition step.
